(19) United States
(12) Patent Application Publication
(10) Pub. No.: US 2008/0227464 A1
(43) Pub. Date: Sep. 18, 2008

(54) Communication System, Server, Terminal, and Communication Control Program

(75) Inventor: Akiko Suito, Tokyo (JP)

Correspondence Address: FOLEY AND LARDNER LLP;SUITE 500, 3000 K STREET NW, WASHINGTON, DC, 20007, US

(73) Assignee: NEC CORPORATION, TOKYO (JP)

(21) Appl. No.: 11/884,956

(22) PCT Filed: Feb. 23, 2006
(86) PCT No.: PCT/JP06/03919

§ 371 Date: Aug. 23, 2007

(30) Foreign Application Priority Data
Feb. 24, 2005 (JP) 2005-049787

(51) Int. Cl. H04Q 7/20

(52) U.S. Cl. 455/456.1

(57) ABSTRACT

It provides a communication system in which a calling party calls a called party on a move and the called party performs a multimedia communication with the calling party, using the communication terminal of a business company providing a communication service. In the communication system in which the communication terminal 110 of the calling party and the communication terminal 120 of the business company providing the communication service are connected through a network 100 to establish a communication between the communication terminal 110 of the calling party and the communication terminal 120 of the business company used by the called party, the position of the mobile terminal 50 is specified upon a call request from the communication terminal 110 of the calling party to the mobile terminal 50 carried by the called party, the communication terminal 120 of the business company near the mobile terminal 50 of the called party is searched, the information about the communication terminal 120 is informed to the mobile terminal 50, and the communication terminal 120 is controlled to start the operation of the multimedia communication.

### TECHNICAL FIELD

The invention relates to a communication system, and more specifically, it relates to a communication system, a server, a terminal, and a communication control program capable of calling a user on a move at the called side so that the called user establishes multimedia communication with a user at the calling side by using a communication terminal.

### BACKGROUND ART

Widespread and sophisticated use of multimedia communication allows users away from home or moving to gain access to a network, by using a mobile terminal including a note PC (Personal Computer), a PDA (Personal Digital Assistance), and a cell phone, or under the circumstance such as remote office and hot spot.

Some companies begin to introduce a new office style by rebuilding a network on the occasion of relocating their offices. As the new office style, a ubiquitous office of free desk type attracts attention, in which a broad band wireless LAN is adopted and people work by using communication terminals at their desired places.

When a user tries to establish multimedia communication with another user under this circumstance, a user at the calling side (hereinafter, it will be referred to as a calling party) gives a communication call to a user at the called side (hereinafter, it will be referred to as a called party) through a terminal. When the contact address of a called party is not informed to the communication system, however, there is a problem that a calling party cannot establish the communication connection. Especially, when a called party is on the move, it becomes more difficult for a calling party to establish a communication connection.

Examples of the conventional communication system are described in, for example, Japanese Patent Publication Laid-Open No. 05-207545 (Patent Document 1), Japanese Patent Publication Laid-Open No. 07-50723 (Patent Document 2), Japanese Patent Publication Laid-Open No. 2004-153352 (Patent Document 3), and Japanese Patent Publication Laid-Open No. 2000-049901 (Patent Document 4).

The method disclosed in Patent Document 1 relates to an incoming call control of wireless terminal in an emergency phone system. The targeted system is an emergency contact system, in which when an emergency situation occurs while a plurality of guards are going on patrol, a wireless terminal of the guard near the emergent location is called to make him or her rush there.

In the method of Patent Document 1, previously registered positional information including the terminal identifier is periodically transmitted from a wireless terminal by hand or automatically and the previously registered positional information is stored in a central controller as the positional information of the wireless terminal. In the event of emergency, the wireless terminal of a guard near the emergent location is called based on the positional information of the wireless terminal to make him or her rush there.

The method of Patent Document 2 relates to a cordless phone system of multi-zone type. An extension service using an electronic automatic exchange is supposed to use an extension phone with cord fixedly, and when a user carries the phone with him or her, another user cannot make contact with him or her in an emergency. Therefore, the system is to solve the above problem as follows.

In the method of Patent Document 2, when someone wants to make contact with a carrying user of a cordless phone immediately but it is impossible, the incoming call is transmitted to an extension phone with cord within a calling area to which a mobile station belongs so that a third party informs the carrying user of the cordless phone that he or she has received the call.

In Patent Document 3, a called party manages the using condition of media for every available terminal by using a server. Owing to it, when a user makes a call to a called party using a plurality of terminals, a suitable terminal may be selected based on the priority of the terminals managed by the server and the presence of the terminal (check whether there is the media being used).

In Patent Document 4, a called party manages the using condition of a tool for every available communication tool through a server. Owing to this, the called party can obtain the information of the using tool and select a suitable communication tool.

Patent Document 1 Japanese Patent Publication Laid-Open No. 05-207545

Patent Document 2 Japanese Patent Publication Laid-Open No. 07-50723

Patent Document 3 Japanese Patent Publication Laid-Open No. 2004-153352

Patent Document 4 Japanese Patent Publication Laid-Open No. 2000-049901

The above mentioned related arts respectively have the following problems.

The method of Patent Document 1 aims to specify the position of a called party, which is different from the exemplary object of the invention to call a called party on a move in order that the called party establishes the multimedia communication between him or her and a calling party by using a communication terminal of a communication service provider.

The method of Patent Document 1 is not to provide a method for indicating to a called party the position of a proper communication terminal capable of multimedia communication, which is required by a called party on a move, that is the object of the invention.

The method of Patent Document 2 is to transfer an incoming call to an extension phone with cord even when it is impossible to make contact with a carrying user of a cordless phone so that a responder may make contact with the carrying user of the cordless phone, but it does not make it possible to establish a direct communication connection from the communication terminal to a receiver.

The method of Patent Document 3 is a method in the case where a connection to a terminal of a called party can be established, not to provide a connection method in the case where a connecting destination of a called party is not informed to the communication system.

The method of Patent Document 4 is to manage the using condition of the tools, not to provide a connecting method in the case where a connecting destination of a called party is not informed to the communication system.

### SUMMARY

In order to resolve the problems of the above mentioned related arts, an exemplary object of the invention is to provide a communication system, a server, a terminal, and a communication control program capable of calling a called party on a move so that the called party may establish the multimedia communication with a calling party by using a communication terminal.

According to a first exemplary aspect of the invention, a communication system of performing a data communication between a plurality of communication terminals connected through a network, in which a specified one, of the communication terminals, requesting a communication with a specified user having a mobile terminal informs the mobile terminal of the specified user of positional information for specifying position of the communication terminal usable by the specified user.

According to a second exemplary aspect of the invention, a server for use in a communication system of performing a data communication between a plurality of communication terminals connected through a network, in which

upon request of a communication with a specified user having a mobile terminal, the specified communication terminal informs the positional information for specifying position of the communication terminal usable by the specified user, of the communication terminals to the mobile terminal of the specified user.

According to a third exemplary aspect of the invention, a mobile terminal carried by a specified user receiving a communication request from a specified one, of a plurality of communication terminals, for performing a data communication, connected through a network, which

obtains the positional information for specifying the position of the communication terminal usable by the specified user, of the plurality of the communication terminals.

### BRIEF DESCRIPTION OF THE DRAWINGS

FIG. 1 is a block diagram showing the structure of a communication system according to a first exemplary embodiment of the invention;

FIG. 2 is a flow chart for describing the schematic operation of the communication system according to the first exemplary embodiment of the invention;

FIG. 3 is a flow chart for describing the operation of a calling party according to the first exemplary embodiment of the invention;

FIG. 4 is a flow chart for describing the operation for calling and controlling a communication terminal according to the first exemplary embodiment of the invention;

FIG. 5 is a flow chart for describing the operation of a called party according to the first exemplary embodiment of the invention;

FIG. 6 is a block diagram showing the structure of a communication system according to a second exemplary embodiment of the invention;

FIG. 7 is a flow chart for describing the operation for calling and controlling a communication terminal according to the second exemplary embodiment of the invention;

FIG. 8 is a block diagram showing the structure of the communication system according to the first exemplary embodiment of the invention;

FIG. 9 is a view showing an example of communication terminal identification information stored in a database according to the first exemplary embodiment of the invention;

FIG. 10 is a view showing an example of IP phone identification information stored in the database according to the first exemplary embodiment of the invention;

FIG. 11 is a view showing an example of search policy information stored in the database according to the first exemplary embodiment of the invention;

FIG. 12 is a flow chart for describing the operation of the communication system for a calling party calling a called party according to the first exemplary embodiment of the invention;

FIG. 13 is a view showing an example of a screen for setting a calling condition according to the first exemplary embodiment of the invention;

FIG. 14 is an example of a reply request displayed on the screen of an IP phone according to the first exemplary embodiment of the invention;

FIG. 15 is a block diagram showing the structure of the communication system according to the second exemplary embodiment of the invention;

FIG. 16 is a view showing an example of communication terminal identification information stored in the database according to the second exemplary embodiment of the invention;

FIG. 17 is a view showing an example of mobile phone identification information stored in the database according to the second exemplary embodiment of the invention; and

FIG. 18 is a flow chart for describing the operation of the communication system for a calling party calling a called party according to the second exemplary embodiment of the invention.

### EXEMPLARY EMBODIMENT

Hereinafter, exemplary embodiments according to the invention will be described.

### First Exemplary Embodiment

A first exemplary embodiment of the invention will be described referring to the drawings.

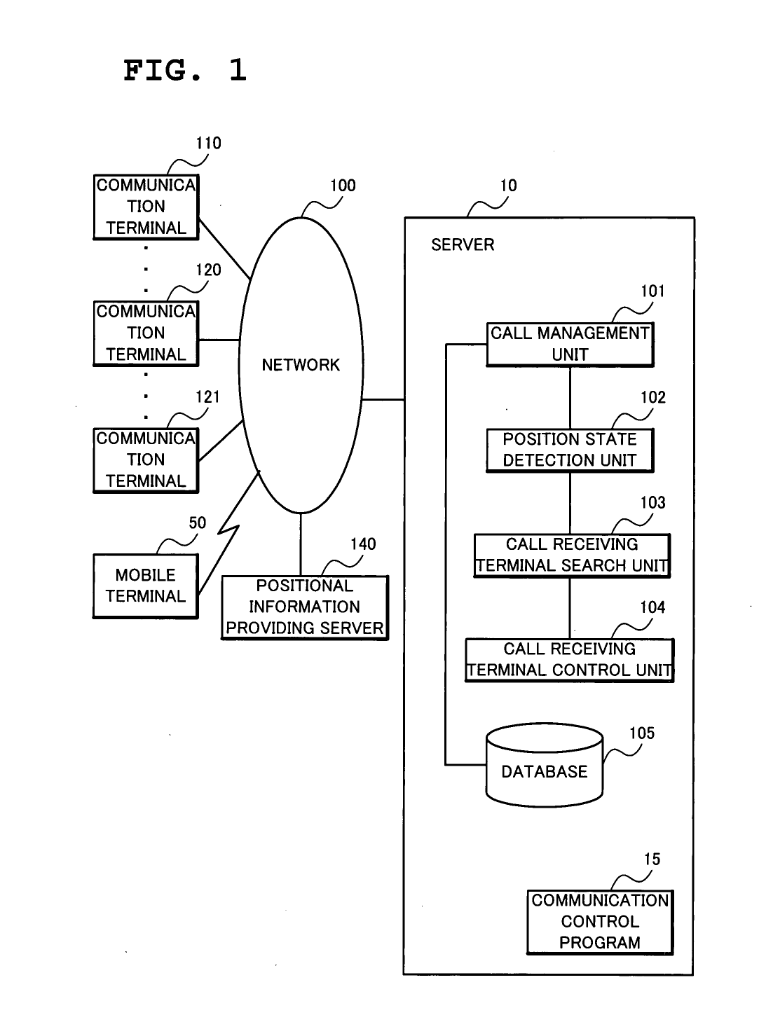

FIG. 1 is a block diagram showing the structure of a communication system according to the exemplary embodiment.

Referring to FIG. 1, the communication system according to the exemplary embodiment comprises a server 10, a communication terminal 110, communication terminals 120 and 121, a mobile terminal 50, and a positional information providing server 140. The server 10, the communication terminal 110, the communication terminals 120 and 121, the mobile terminal 50, and the positional information providing server 140 are connected to each other through a network 100.

The communication system according to the exemplary embodiment corresponds to a communication function with multimedia data including video, image, and sound.

The communication system according to the exemplary embodiment is a system in which, when a call request is made from a communication terminal of a calling party to a mobile terminal 50 carried by a called party on a move, the called party searches an available communication terminal to realize multimedia communication through the communication terminals between the calling party and the called party. The network 100 is formed by one or various kinds of communication lines.

In the invention, it is assumed that the multimedia communication between a calling party and a called party contains business document information and image information of large capacity and that the communication terminals 110, 120, and 121 are used fixedly. Therefore, the communication terminals 110, 120, and 121 are supposed to be computers such as a desktop personal computer, a workstation, and the like. Portable personal computers of laptop-type, note-type, and book-type are also covered.

In the case of a communication with small information amount, the communication terminal may be a PDA or a mobile phone.

The server 10 according to the exemplary embodiment is to control the communication operation, and upon receipt of a call request from a calling party, it checks the position of a called party and informs the called party of his or her usable communication terminal.

The communication terminal 110 is a terminal corresponding to the multimedia communication, which is used by a calling party.

The communication terminals 120 and 121 are communication terminals provided by a business company providing communication service. The communication service providing business company may be telecommunications carriers or any other business company providing the communication terminals. Though the communication terminals 120 and 121 are mainly set at public place, they may be set at hot spots, Internet cafes, and the like.

The business company providing a communication service provides a service for realizing multimedia communication between a calling party and a called party according to the invention.

The communication terminals 120 and 121 are the terminals corresponding to the multimedia communication which can be used by a user on a move. A plurality of communication terminals 120 and 121 are set and a called party uses the communication terminals 120 and 121 set near his present position.

The mobile terminal 50 is a terminal always carried by a called party. The mobile terminal 50 specifies the own terminal position and provides the positional information to the positional information providing server 140. The positional information specified by the mobile terminal 50 comprises a combination of latitude data and longitude data or a combination of latitude data, longitude data, and altitude data. When the positional information specified by the mobile terminal 50 comprises the latitude data, the longitude data, and the altitude data, the altitude data may be generated by the mobile terminal 50 including a GPS (Global Positioning System) or it may be read out from a topographical map with the latitude data and the longitude data specified.

The mobile terminal 50 may comprise an IC card or an IC tag, a reader which reads the above, and a device which may specify the positional information. The mobile terminal 50 may be combined with the GPS.

The mobile terminal 50 according to the exemplary embodiment comprises a mail function. The mobile terminal 50 comprises one of a vibration function, a sound function, or a buzzer function, in order to enable a called party to be aware of the receipt of a mail upon receipt of it. The mobile terminal 50 may be provided with a call function.

The server 10 comprises a call management unit 101, a position state detection unit 102, a call receiving terminal search unit 103, a call receiving terminal control unit 104, and a database 105.

The call management unit 101 is a means for managing a call request from a calling party, which can receive a call request from a calling party and manage the communication terminal identification information. In the call management unit 101, the terminal information of the communication terminals 110, 120, and 121 and the mobile terminal 50 is stored in the database 105.

The position state detection unit 102 is a means for detecting the position of a called party, which can search the position of the mobile terminal 50 carried by a called party.

The call receiving terminal search unit 103 is a means for searching a communication terminal to be used by a called party and transmitting a reply request to the called party, which can search the communication terminal a called party uses from the communication terminals in the vicinity where the called party stays.

The call receiving terminal control unit 104 is a means for controlling the communication terminal a called party uses, which can control the receiving operation of an incoming call for the communication terminal the called party uses.

The positional information providing server 140 provides the positional information of the mobile terminal 50. Upon receipt of an inquiry about the position of the mobile terminal 50 from the position state detection unit 102, the positional information providing server 140 can provide the positional information of the mobile terminal 50 to the position state detection unit 102.

The positional information providing server 140 obtains the positional information of the mobile terminal 50 including the latitude and longitude data, or the latitude, longitude, and altitude data from the mobile terminal 50.

The server 10 according to the exemplary embodiment may be of a server-side application type which performs applications only on a server, of a type which provides the applications from a server to a client, or of the application dedicated type, or a combination of them.

An application for multimedia communication used by the communication terminals 120 and 121 and the mobile terminal 50 may be a windows (R) application, a java (R) applet, a Web application, or a combination of them. The communication terminals 120 and 121 and the mobile terminal 50 may be the application dedicated devices.

The function of the invention is characterized in that when a call request is made from the communication terminal 110 of a calling party to the mobile terminal 50 carried by a called party on a move, the position state detection unit 102 specifies the position of the mobile terminal 50, the call receiving terminal search unit 103 searches the communication terminals 120 and 121 of a business company providing a communication service near the mobile terminal 50, and that the call receiving terminal control unit 104 informs the communication terminals 120 and 121 of the information for starting the operation of the multimedia communication. It may be realized by installing the circuitry with a program for realizing the above function built-in, in a computer. Alternatively, a program (application) for realizing the characteristic function of the invention may be stored in a storing medium and the program may be executed by a computer, thereby making the computer work as the server 10.

Next, the schematic operation of the communication system according to the exemplary embodiment will be described.

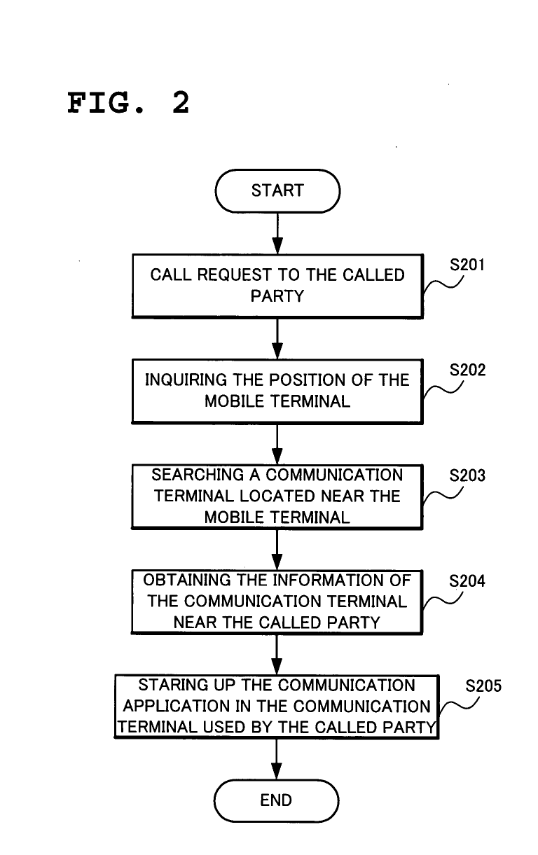

FIG. 2 is a flow chart for describing the schematic operation of the communication system according to the exemplary embodiment. Depending on necessity, the relevant portions of FIG. 1 are referred to.

Referring to FIG. 2, when a calling party starts a communication with a called party, the calling party requests a call to the server 10 at first by specifying the called party through the communication terminal 110 (Step S201).

When the call management unit 101 receives the call request for calling the called party, the server 10 searches the identification information of the mobile terminal 50 carried by the called party and the position state detection unit 102 inquires the position of the mobile terminal 50 of the positional information providing server 140 based on the identification information (Step S202).

The identification information of the mobile terminal 50 means the information capable of uniquely identifying a terminal, for example, a phone number of the mobile terminal 50 or individual identification number.

The positional information providing server 140 obtains the positional information specified by the mobile terminal 50 from the mobile terminal 50, and when the position state detection unit 102 inquires about the position, it transmits the corresponding positional information specified by the mobile terminal 50.

The call receiving terminal search unit 103 searches the communication terminal 120 of the business company providing communication service which is set near the mobile terminal 50 from the communication terminals registered by the call management unit 101 in advance, based on the positional information of the mobile terminal 50 obtained from the positional information providing server 140 (Step S203).

Hereinafter, a description will be made assuming that the communication terminal 120 is the communication terminal set near the called party.

Next, the call receiving terminal search unit 103 obtains the information of the communication terminal 120 set near the called party (Step S204).

In order to make possible that the called party establishes the communication by using the communication terminal 120, the call receiving terminal control unit 104 starts up a communication application in the communication terminal 120 (Step S205).

The schematic operation of the communication system according to the exemplary embodiment has been described as mentioned above. Next, an operation of a calling party, an operation for calling and controlling the communication terminal 120, and an operation of a called party according to the exemplary embodiment will be described in this order.

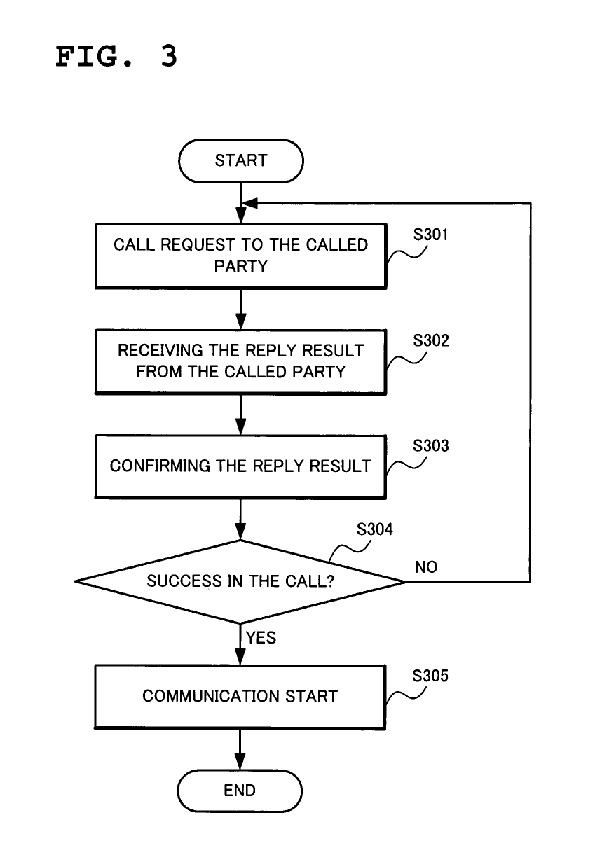

FIG. 3 is a flow chart for describing the operation of a calling party according to the exemplary embodiment. In the following description, the relevant parts of FIG. 1 will be referred to depending on the necessity.

Referring to FIG. 3, at first, a calling party specifies a called party in the communication application on the communication terminal 110. When the calling party specifies the identification information of the mobile terminal 50, a call request for calling the specified called party is sent to the server 10 (Step S301).

In Step S301, in the case where the call management unit 101 registers both the ID (identification number) specifying the called party and the identification information of the mobile terminal 50 carried by the called party in advance, the calling party may specify the ID of the called party in the communication application. The ID (identification number) specifying the called party and the identification information of the mobile terminal 50 carried by the called party are stored in the database 105.

The communication terminal 110 of the calling party receives a reply result of the called party from the server 10 (Step S302).

The communication application performed in the communication terminal 110 checks the received reply result of the called party (Step S303).

When a call to the called party is succeeded (Step S304), a network connection is prepared between the communication terminal 110 of the calling party and the communication terminal 120 used by the called party. When the connection between the communication terminal 110 of the calling party and the communication terminal 120 used by the called party is established, the communication between the both communication terminals starts (Step S305).

On the other hand, when there is no reply from the called party or when the called party's rejection is confirmed (Step S304), the communication application restores the state back to the previous one before the called party is specified.

Next, the operation of calling and controlling the communication terminal 120 according to the exemplary embodiment will be described.

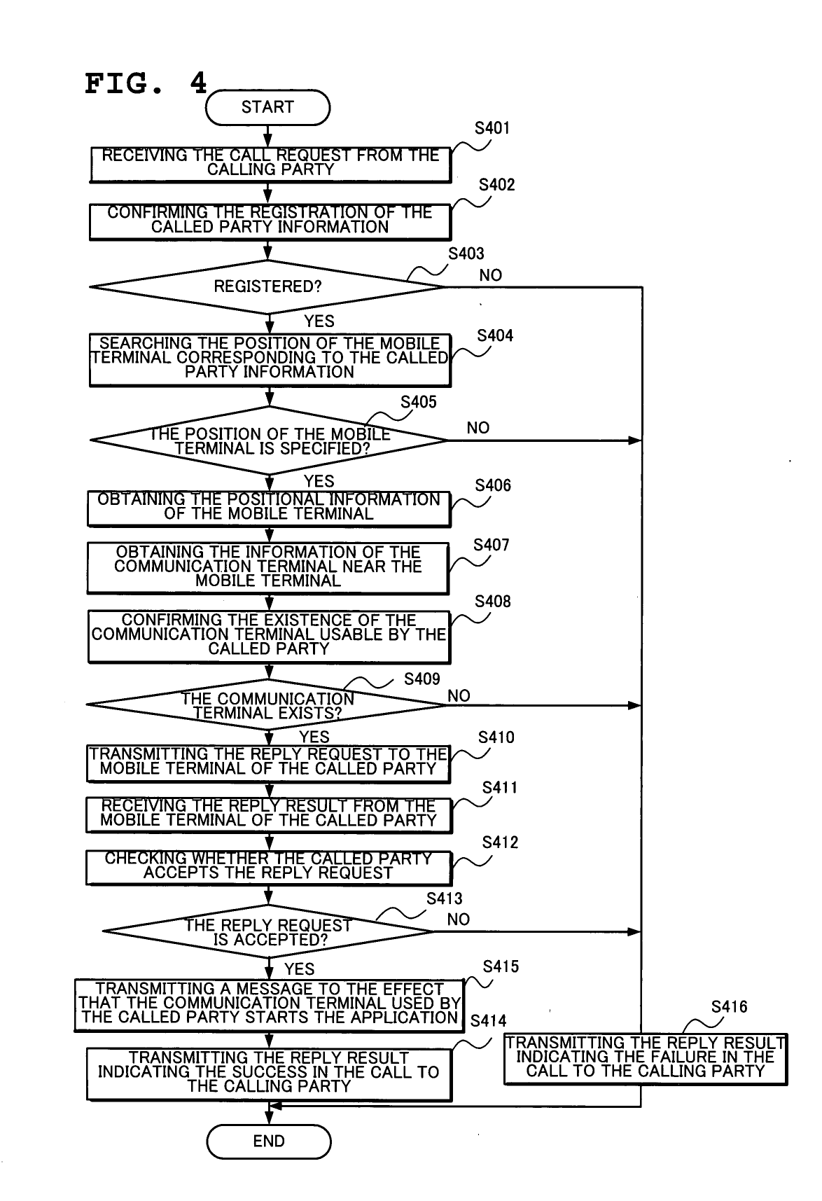

FIG. 4 is a flow chart for describing the operation of calling and controlling the communication terminal 120 according to the exemplary embodiment. In the following description, the relevant portions of FIG. 1 are referred to depending on the necessity.

Before the business company starts the system operation, a system manager specified by a business company which provides a communication service registers the identification information of the communication terminal 120 of his or her business company in advance through the call management unit 101 of the server 10. The system manager also registers the identification information of the mobile terminal 50 carried by a user using the communication system in advance in the same way. Here, the identification information of the communication terminal 120 and the mobile terminal 50 includes the telephone number data, network address data, individual identification number data which can uniquely identify each terminal. The system manager also registers the meta data showing the position of the corresponding communication terminal (for example, latitude data, longitude data, altitude data, address data, and the like) in advance as attached information for the identification information of the communication terminal.

Referring to FIG. 4, at first, the call management unit 101 set in the server 10 receives a call request from the communication terminal 110 of the calling party (Step S401).

The call request includes the information on the called party. The called party information is the identification information of the mobile terminal 50 carried by the called party, including the telephone number data, the network address data, the individual identification number data for uniquely identifying the mobile terminal 50.

Upon receipt of the call request, the call management unit 101 checks whether the called party information included in the call request is registered in the server 10 in advance (Step S402).

When the call management unit 101 judges that the called party information included in the call request is not registered in advance, it moves to the operation of Step S416 (Step S403).

When registering the called party information in advance, in the case where the ID identifying the called party itself is also registered in addition to the identification information of the mobile terminal 50 carried by the called party, the ID of the called party itself may be used as the called party information in Step S401.

In this case, the call management unit 101 may search the identification information of the mobile terminal 50 registered beforehand together with the ID of the called party included in the call request in Step S402.

When it is judged that the specified called party information has already been registered in advance (Step S403), the call management unit 101 provides the corresponding called party information to the position state detection unit 102. The position state detection unit 102 makes the positional information providing server 140 search the positional information of the mobile terminal 50 corresponding to the called party information (Step S404).

When the positional information providing server 140 can determine the position of the mobile terminal 50 (Step S405), the position state detection unit 102 obtains the present positional information of the corresponding mobile terminal 50 from the positional information providing server 140 (Step S406).

The positional information comprises a combination of the latitude data and the longitude data or a combination of the latitude data, the longitude data, and the altitude data.

In Step S404, when the position of the corresponding mobile terminal 50 cannot be determined (Step S405), the position state detection unit 102 inquires the detailed present position information of the mobile terminal 50 of the called party through the positional information providing server 140. In this case, the mail function of the mobile terminal 50 is used.

For example, when the called party is in the fifth floor and a parameter of the meta data showing the position obtained from the positional information providing server 140 is only the latitude and the longitude, the unit 102 inquires which floor the called party is in of his or her mobile terminal 50. The called party replies to the inquiry through a mail. The mail should be replied from the position state detection unit 102 in a format capable of analyzing the positional information, in order that the position state detection unit 102 may determine the correct position.

The position state detection unit 102 determines the correct position of the called party and arranges the search results of the communication terminals which may be used by the called party based on the determined position.

In the case where it inquires the detailed present positional information of the mobile terminal 50 of the called party but it cannot determine the correct position of the called party, the call management unit 101 transmits the reply result indicating the failure in the call to the communication terminal 110 of the calling party (Step S416).

Next, a flow after obtaining the present positional information of the mobile terminal 50 in Step S406 will be described.

The position state detection unit 102 provides the positional information of the mobile terminal 50 to the call receiving terminal search unit 103. Based on the positional information of the mobile terminal 50 corresponding to the called party information, the call receiving terminal search unit 103 obtains the terminal information of the communication terminal 120 set in the vicinity where the corresponding mobile terminal 50 stays, from the information of the communication terminal which has been registered in advance (Step S407).

In Step S407, by setting a search policy for searching a proper communication terminal according to the situation of the calling party, flexible search can be realized. For example, the search policy for determining whether the search target communication terminals are narrowed is set according to waiting time of calling. The search policy is set by the calling party.

When the calling party sets the call waiting time short, a communication terminal set nearest to the called party's mobile terminal 50 is searched. When the calling party does not set the call waiting time (it is OK that the waiting time is long), a communication terminal set within hundreds meters from the position of the mobile terminal 50 of the called party is searched. The search policy data is stored in the database 105 by the call management unit 101 or the call receiving terminal search unit 103.

The called party may use the communication terminal which fills the above mentioned search policy data and is not in current use.

The call receiving terminal search unit 103 checks whether there is the communication terminal 120 the called party can use (Step S408).

When the terminal information of the communication terminal 120 usable by the called party cannot be obtained, the operation moves to Step S416 (Step S409).

When the communication terminal 120 usable by the called party is determined in Step S409, the call receiving terminal search unit 103 transmits the information about the presence of a call request from the calling party and the reply request to the mobile terminal 50 of the called party (Step S410).

The reply request includes the information about the setting place of the communication terminal 120 to be used to reply to the call by the called party.

The call receiving terminal search unit 103 receives the reply result from the mobile terminal 50 of the called party (Step S411) in response to the reply request in Step S409.

The call receiving terminal search unit 103 checks the contents of the received reply result and whether the called party accepts the reply request (Step S412).

When it is judged from the received reply result that the called party refuses the reply, the operation moves to Step S416 (Step S413).

When it is judged that the called party accepts the reply request in Step S412, a message for starting up the communication application is transmitted to the communication terminal 120 used by the called party (Step S414).

The message for starting up the communication application means an execution command for starting the application and the URL (Uniform Resource Locator) of the application site.

Next, the reply result showing a success in the call is transmitted to the communication terminal 110 of the calling party (Step S415).

When the designated called party information is not found in Step S403, the call management unit 101 transmits the reply result showing a failure in the call to the communication terminal 110 of the calling party (Step S416).

When the position of the mobile terminal 50 cannot be specified in Step S405, when the communication terminal usable by the called party is not found in Step S409, or when the reply cannot be obtained from the called party in Step S413, the call receiving terminal search unit 103 transmits the reply result showing the failure in the call to the communication terminal 110 of the calling party (Step S416).

Next, the operation of the called party will be described.

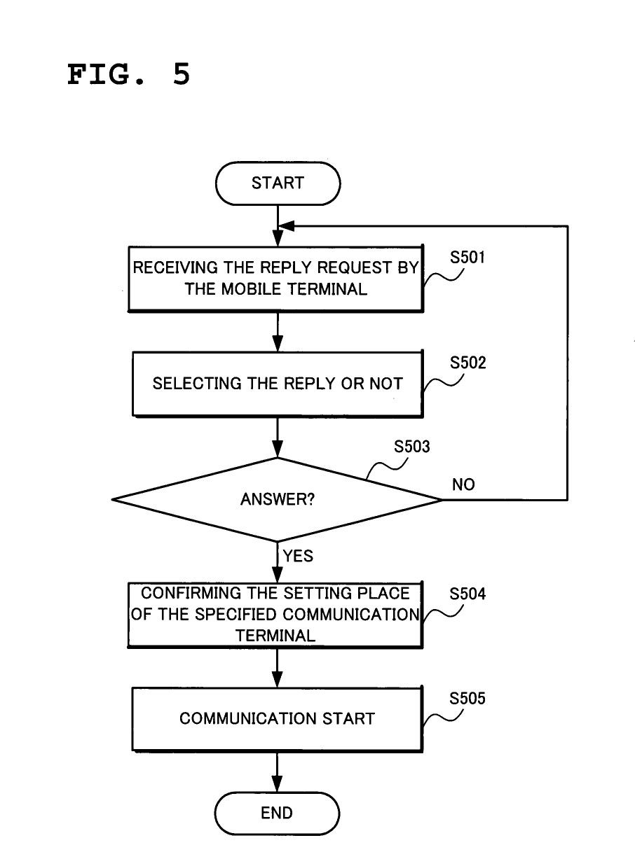

FIG. 5 is a flow chart for describing the operation of the called party according to the exemplary embodiment. In the following description, the relevant portions of FIG. 1 are referred to depending on the necessity.

At first, the called party receives a reply request from the server 10, in his or her carrying mobile terminal 50 (Step S501).

As a method for displaying a reply request, its message may be displayed on a liquid crystal screen of the mobile terminal 50 or the incoming call may be registered as a phone call, hence to reproduce the voice message.

The called party selects whether or not to reply to the reply request displayed on the mobile terminal 50 (Step S502).

When he or she refuses the reply (Step S503), the refusal of the reply is informed to the server 10, and the operation returns to the call waiting state in Step S501.

When the called party does not reply to the reply request after a predetermined elapse of time, he or she informs the server 10 of the reply result showing his or her unavailable state and the operation returns to the call waiting state in Step S501. Such a time out after the predetermined time is set by the server 10.

When the called party selects a reply (Step S503), the setting place of the communication terminal 120 specified by the server 10 is displayed on the mobile terminal 50. As the method for displaying the setting place, the message may be displayed on the liquid crystal screen of the mobile terminal 50 or the voice message may be reproduced. Based on the displayed information, the called party confirms the setting place of the specified communication terminal 120 (Step S504).

The called party moves to the setting place of the communication terminal 120 specified by the server 10 and starts to communicate with the calling party by using the communication application on the communication terminal 120 (Step S505).

As mentioned above, the communication system according to the exemplary embodiment is a communication system in which the communication terminal 110 of the calling party is connected to the communication terminal 120 of the business company providing the communication service through the network 100 and the communication is established between the communication terminal 110 of the calling party and the communication terminal 120 of the business company used by the called party. When a call request is transmitted from the communication terminal 110 of the calling party to the mobile terminal 50 carried by the called party, the system specifies the position of the mobile terminal 50, searches the communication terminal 120 of the business company near the mobile terminal 50 of the called party, informs the mobile terminal 50 of the information on the communication terminal 120, and informs the communication terminal 120 of the information for starting up the operation of the multimedia communication.

Though in the exemplary embodiment, an example for establishing the multimedia communication between the calling party and the called party has been described, it is needless to say that the exemplary embodiment can be similarly applied to the communication other than the multimedia communication.

According to the exemplary embodiment, it is possible that a calling party calls a called party on a move and that the called party establishes a multimedia communication with the calling party by using the communication terminal 120 of the business company providing a communication service.

This is because the communication terminal 120 of the business company providing the communication service near the called party is searched based on the positional information of the called party specified by his or her carrying mobile terminal 50 and the positional information of the communication terminal 120 to be used by the called party is provided to the called party.

According to the exemplary embodiment, the calling party can establish the multimedia communication with the called party on a move without a third party other than the calling party and the called party.

The server 10 of the invention may be realized in a way of software by running the communication control program (application) 15 which carries out the above mentioned means, in the server 10 that is a computer processor. The communication control program 15 is stored in a recording medium such as a magnetic disk, a semiconductor memory, and the like and loaded from the recording medium into the server 10 to control its operation, thereby realizing the above mentioned functions.

### Second Exemplary Mode

Hereinafter, a second exemplary embodiment of the invention will be described referring to the drawings.

FIG. 6 is a block diagram showing the structure of a communication system according to the exemplary embodiment.

Referring to FIG. 6, the communication system according to the exemplary embodiment comprises a server 20, a communication terminal 110, communication terminals 120 and 121, a mobile terminal 60, and a positional information providing server 150. The communication system according to the exemplary embodiment corresponds to a communication function using the multimedia data including video, image, and sound similarly to the first exemplary embodiment.

Similarly to the case of the first exemplary embodiment, the communication system according to the exemplary embodiment is a system which realizes the multimedia communication between the communication terminal of the calling party and the called party.

The server 20, the communication terminal 110, the communication terminals 120 and 121, the mobile terminal 60, and the positional information providing server 150 are connected to each other through the network 100. The network 100 is formed by one or various kinds of communication lines.

The server 20 is a server which receives a call request from the communication terminal 110 of the calling party, comprising a call management unit 101 and a database 105. The call management unit 101 can receive a call request from the calling party.

The communication terminal 110 is a terminal corresponding to the multimedia communication, for use in the calling party.

Similarly to the case of the first exemplary embodiment, the communication terminals 120 and 121 are the communication terminals of the business company providing the communication service.

The communication terminals 120 and 121 used by the called party and the terminal identification information for uniquely identifying the mobile terminal 60 are stored in the database 105 by the call management unit 101. The terminal identification information of the communication terminal 110 used by the calling party is also stored in the database 105.

In the case of a communication with small information amount, the communication terminal may be a PDA or a mobile phone.

The mobile terminal 60 according to the exemplary embodiment is carried by the called party, comprising a position state detection unit 102, a call receiving terminal search unit 103, and a call receiving terminal control unit 104. The mobile terminal 50 according to the first exemplary embodiment does not have the above units but its function is different from the function of the mobile terminal 60 according to the exemplary embodiment.

The mobile terminal 60 can determine the own position from the positional information of the positional information providing server 150 received from the server 150 itself, which will be described later, and the intensity and propagation direction of the electric wave received from the positional information providing server 150.

The functions of the position state detection unit 102, call receiving terminal search unit 103, and the call receiving terminal control unit 104 provided in the mobile terminal 60 are as follows and they are the same as the respective functions in the first exemplary embodiment.

The position state detection unit 102 has a function for searching the position of the mobile terminal 50 carried by the called party.

The call receiving terminal search unit 103 has a function for searching a terminal which can be used by the called party from the terminals in the vicinity where he or she stands.

The call receiving terminal control unit 104 has a function for controlling the starting operation of receiving a call for the terminal used by the called party.

The positional information providing server 150 has a function for transmitting the positional information of the own server to the mobile terminal 60 upon receipt of an inquiry from the position state detection unit 102 or at regular intervals.

The positional information providing server 140 according to the first exemplary embodiment has the function for obtaining the positional information specified by the mobile terminal 50 from the mobile terminal 50 in advance and transmitting the positional information specified by the corresponding mobile terminal 50 upon receipt of the inquiry from the position state detection unit 102. Though the positional information providing server 140 according to the first exemplary embodiment does not have a function for specifying its position, the positional information providing server 150 according to this exemplary embodiment has the function for specifying the position of the self server. In this way, the function of the positional information providing server 150 according to the exemplary embodiment is different from the function of the positional information providing server 140 according to the first exemplary embodiment.

The function characterized by the invention in that when a call request is made from the communication terminal 110 of the calling party to the mobile terminal 60 carried by the called party, the position state detection unit 102 specifies the position of the mobile terminal 60, the call receiving terminal search unit 103 searches the communication terminals 120 and 121 of the business company providing the communication service near the mobile terminal 60, and the call receiving terminal control unit 104 informs the communication terminals 120 and 121 of the information for starting the operation of the multimedia communication, may be realized by installing the circuitry with a program for realizing the above function in a computer. Alternatively, a program (application) for realizing the characteristic function of the invention may be stored in a storing medium and executed by a computer, thereby making it work as the mobile terminal 60.

Next, the schematic operation of the communication system according to the exemplary embodiment will be described. Because the schematic operation of the communication system according to the exemplary embodiment is the same as the first exemplary embodiment, it will be described referring to FIG. 2. The relevant portions of FIG. 6 are referred to depending on the necessity. The procedures for calling the called party so that the calling party starts the communication are the same in the case of the first exemplary embodiment.

Referring to FIG. 2, at first, the server 20 receives a call request to the called party in the call management unit 101 (Step S201).

The server 20 searches the identification information of the mobile terminal 60 carried by the called party and based on the identification information, it informs the mobile terminal 60 of the call request. The identification information of the mobile terminal 60 includes the information on the telephone number data and the individual identification number data.

The position state detection unit 102 receives the positional information of the positional information providing server 150 from the server 150 itself, and based on the positional information of the positional information providing server 150, it requires the position of the mobile terminal 60 (Step S202).

The position of the mobile terminal 60 is required as below. Upon receipt of the inquiry from the position state detection unit 102 or at regular intervals, the positional information providing server 150 transmits the own positional information to the mobile terminal 60. Based on the positional information of the positional information providing server 150 and/or the intensity and the propagation direction of the electric waves which are transmitted from the positional information providing server 150, or based on the positional information and the propagation time and propagation direction of the electric waves which are transmitted from the positional information providing server 150, the position state detection unit 102 makes an analysis to specify the position of the mobile terminal 60.

In the analysis, the position of the mobile terminal 60 is determined according to the direction and the distance of the mobile terminal 60 from the position where the positional information providing server 150 is centered and the positional information of the positional information providing server 150. The direction where the mobile terminal 60 stands can be required from the propagation direction of the electric waves and the distance of the mobile terminal 60 can be required from the intensity or the propagation time of the electric waves.

The positional information of the mobile terminal 60 specified by the position state detection unit 102 may be a combination of the latitude data and the longitude data or a combination of the latitude data, the longitude data, and the altitude data.

Of the above data, the latitude data and the longitude data may be read out from a map by the position state detection unit 102 based on the position of the positional information providing server 150.

The altitude data may be read out from a topographic map by specifying the latitude data and the longitude data.

The positional information providing server 150 may be a server having a GPS. The GPS may be provided with a function for measuring the altitude.

The call receiving terminal search unit 103 searches the communication terminal information set near the mobile terminal 60 from the information of the previously registered communication terminals 120 and 121 of the business company providing the communication service (Step S203), and obtains the information of the communication terminal set near the mobile terminal 60 (Step S204).

Here, the called party may add his or her moving area to the search condition. For example, the area information to which the called party will go is added to the search condition, which makes it possible to search a communication terminal near the given area information. A specific addition method will be described in the later explanation about the operation of the called party.

In order to make possible that the called party establishes a communication by using the selected communication terminal 120, the call receiving terminal control unit 104 starts up the multimedia communication application in the communication terminal 120 (Step S205).

As mentioned above, the schematic operation of the communication system according to the exemplary embodiment has been described.

Next, the operation of the calling party, the operation for calling and controlling the communication terminal 120, and the operation of the called party according to the exemplary embodiment will be described in this order.

Since the operation of the calling party according to the exemplary embodiment is the same as that in the first exemplary embodiment, its description is omitted.

The functions of the position state detection unit 102, the call receiving terminal search unit 103, and the call receiving terminal control unit 104 in the exemplary embodiment are the same as the operation according to the first exemplary embodiment. Though these three means are provided in the server 10 in the first exemplary embodiment, they are provided in the mobile terminal 60 in this exemplary embodiment. As the result, it is different from the first exemplary embodiment as follows.

It is different from the operation for calling and controlling the communication terminal 120 according to the first exemplary embodiment in that the operation after Step S404 of FIG. 4 is performed by the mobile terminal 60 of the called party, not by the server 10.

Hereinafter, the operation for calling and controlling the communication terminal 120 according to the exemplary embodiment will be described referring to the drawings.

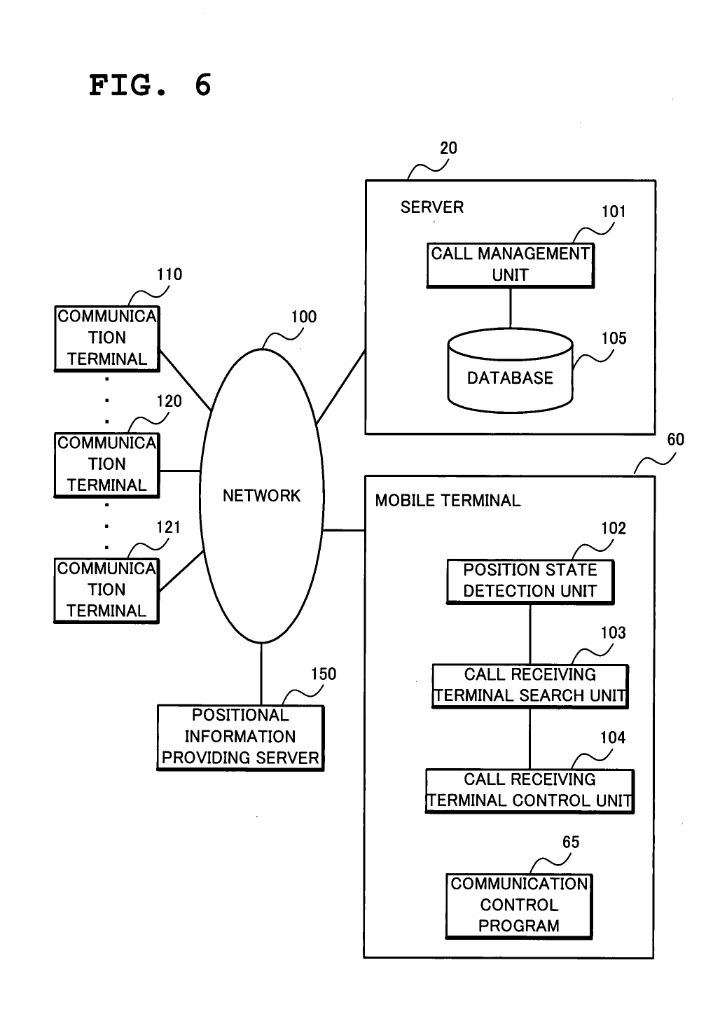

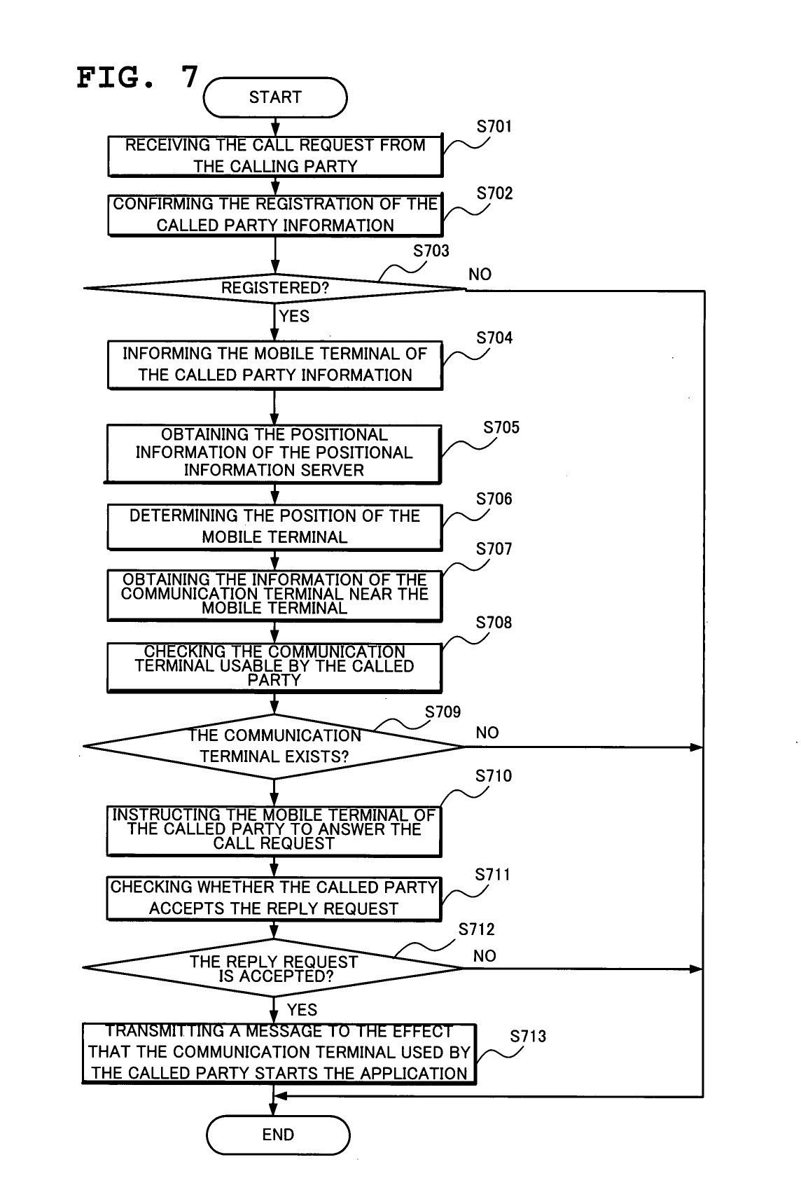

FIG. 7 is a flow chart for describing the operation for calling and controlling the communication terminal 120 according to the exemplary embodiment. In the following description, the relevant portions of FIG. 6 are referred to depending on the necessity.

Referring to FIG. 7, at first, the call management unit 101 set in the server 20 receives a call request from the communication terminal 110 of the calling party (Step S701).

The call management unit 101 of the server 20 checks registration of the called party information included in the call request (Step S702), and when the information has been registered in advance (Step S703), it informs the mobile terminal 60 of the called party information (Step S704).

Here, the called party information is the identification information of the mobile terminal 60 carried by the called party and the information such as the telephone number data and the individual identification number data for specifying the mobile terminal 60.

When the called party information included in the call request is not registered (Step S703), the processing is finished.

The mobile terminal 60 obtains the positional information of the positional information providing server 150 from the server itself (Step S705).

The positional information comprises a combination of the latitude data and the longitude data or a combination of the latitude data, the longitude data, and the altitude data.

The mobile terminal 60 determines the own position considering the intensity and the propagation direction of the electric waves received from the positional information providing server 150 or the propagation time and the propagation direction of the received electric waves (Step S706).

There may be a plurality of positional information providing servers 150. Therefore, in Step S705, the electric waves including their positional information of the positional information providing server may be received from the plurality of positional information providing servers set in different places in various directions. In this case, the position of the mobile terminal 60 can be specified more correctly.

Next, the mobile terminal 60 gains access to the server 20 and obtains the information of the communication terminal 120 near the mobile terminal 60 (Step S707).

The call receiving terminal search unit 103 checks whether there exists the communication terminal 120 used by the called party (Step S708).

When the terminal information of the communication terminal 120 used by the called party is not obtained, the processing is finished (Step S709).

When the communication terminal 120 used by the called party is determined, the call receiving terminal search unit 103 displays such information that there is a call request from the calling party and the reply request on the mobile terminal 50 of the called party (Step S710).

The called party enters a reply corresponding to the reply request into the mobile terminal 50.

The call receiving terminal search unit 103 checks the contents of the reply result and whether or not the called party consents to reply (Step S711).

When it judges that the called party has consented to reply (Step S712), it transmits a message for starting up the communication application to the communication terminal 120 used by the called party (Step S713).

When it judges that the called party does not have consented to reply (Step S712), the processing is finished.

Next, the operation based on the operation of the called party according to the exemplary embodiment will be described.

The operation based on the operation of the called party according to the exemplary embodiment is the same as that based on the operation of the called party in the first exemplary embodiment. By referring to FIG. 5, the operation based on the operation of the called party will be additionally described.

As described in the description of the schematic operation of the communication system according to the exemplary embodiment, when the moving area of the called party is added to the search condition, the mobile terminal 60 displays an input medium of the search condition in Step S504. Then the called party enters his or her moving area. The mobile terminal 60 provides the called party's moving area entered to the call receiving terminal search unit 103 and requests the call receiving terminal search unit 103 to search again.

In Step S505, the called party can operate the starting up control of the application and the starting control of the communication according to the call receiving terminal control unit 104 at his or her desired timing.

In the above-mentioned exemplary embodiment, the example for establishing the multimedia communication between the calling party and the called party has been described, but it is needless to say that the exemplary embodiment can be similarly applied to a communication through a communication medium other than the multimedia communication.

According to the exemplary embodiment, it is possible to call the called party on a move more quickly compared with the case of the first exemplary embodiment, and the called party can establish the multimedia communication with the calling party by using the shared communication terminal 120.

This is because by providing the mobile terminal 60 with the unit for searching and controlling the terminal used by the called party, the communication between the server 10 and the mobile terminal 50 which is required in the communication system according to the first exemplary embodiment is not necessary between the server 20 and the mobile terminal 60 according to this exemplary embodiment, thereby reducing the time lag and the communication cost caused by the transmission of the information.

By adding the called party's moving area to the search condition, it is possible to search the communication terminal 120 to be used considering the situation of the called party.

According to the exemplary embodiment, the calling party can establish the multimedia communication with the called party on a move without a third party other than the calling party and the called party.

The mobile terminal 6b of the invention can, of course, realize its operation in a way of hardware, or it can realize the above operation in a way of software by running the communication control program (application) 65 for carrying out the above units, in the mobile terminal 60 that is a computer processor. The communication control program 65 is stored in a recording medium such as a magnetic disk, a semiconductor memory, and the like and loaded from the recording medium into the mobile terminal 60, to control the operation, thereby realizing the above-mentioned functions.

### First Example

Hereinafter, the first example of the invention will be described in detail referring to the drawing. This example corresponds to the first exemplary embodiment.

In this example, the called party always carries an IP (Internet Protocol) phone 230 with him or her.

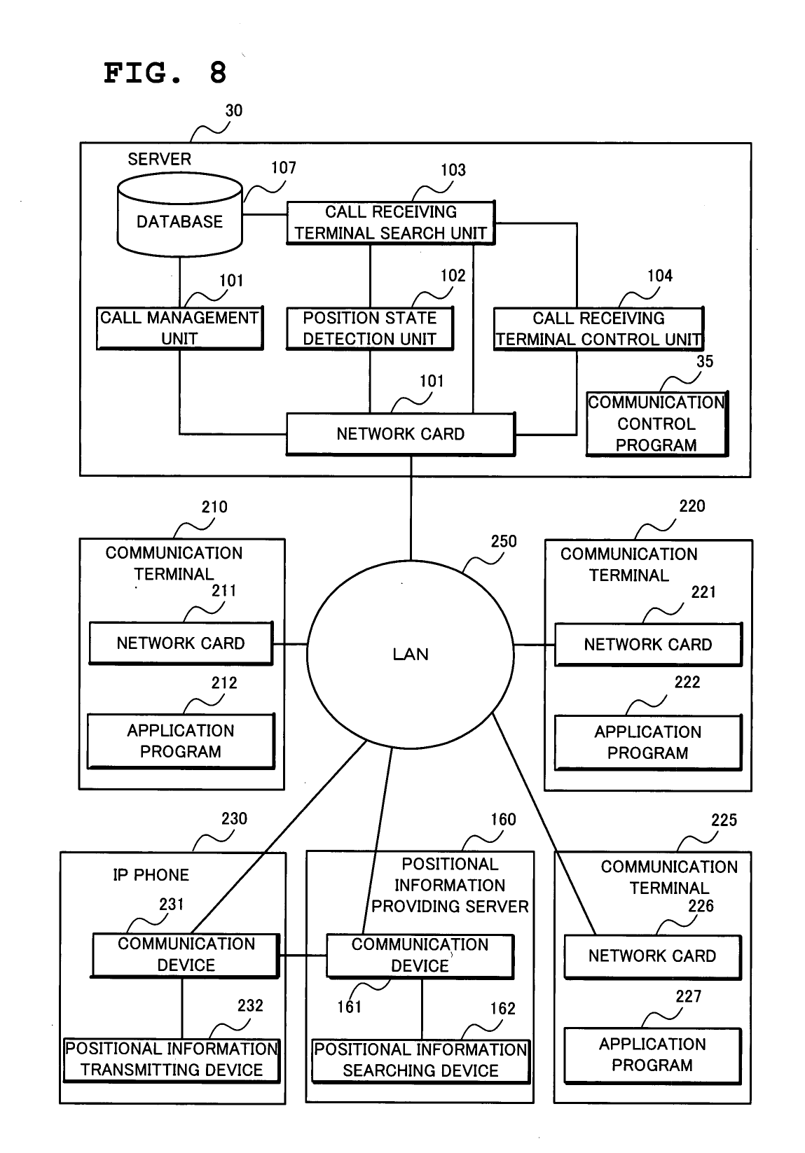

FIG. 8 is a block diagram showing the structure of the communication system according to the example. In the system, a user can hold a conference with a plurality of terminals connected on a network, using multimedia such as image, sound, and data.

Referring to FIG. 8, the communication system according to the example comprises a server 30, a communication terminal 210, communication terminals 220 and 225, the IP phone 230, and a positional information providing server 160. The server 30, the communication terminal 210, the communication terminals 220 and 225, the IP phone 230, and the positional information providing server 160 are connected to each other through a LAN (Local Area Network). The LAN may also include a wireless LAN.

The server 30 comprises the call management unit 101, the position state detection unit 102, the call receiving terminal search unit 103, the call receiving terminal control unit 104, a database 107, and a network card 106 corresponding to an Ethernet (R). The server 30 is connected to a LAN 250 through the network card 106.

The server 30 does not have to be a server dedicated device but it may be a computer for the other use with the program installed there.

The communication terminal 210 is a terminal used by the calling party, corresponding to the multimedia communication and including a network card 211 corresponding to the Ethernet (R). The communication terminal 210 is connected to the LAN 250 through the network card 221. An application program 212 for carrying out the conference application runs in the communication terminal 210.

The communication terminals 220 and 225 are the communication terminals of the business company specified by an organization using the LAN or those of the organization, corresponding to the multimedia communication, to be used by the called party. A plurality of the terminals are provided with the network cards 221 and 226 corresponding to the Ethernet (R).

The application programs 222 and 227 for carrying out the conference application respectively run in the communication terminals 220 and 225. The application program 222 and the application program 227 are both Web applications.

The communication terminals 210, 220, and 225 according to the example have the same functions as the communication terminal according to the first example.

The IP phone 230 is a terminal always carried by the called party, including a communication device 231 capable of wireless communication and a positional information transmitting device 232. The IP phone 230 can be connected to the LAN 250 through the communication device 231. The positional information transmitting device 232 transmits the electric waves to the positional information providing server 160 at regular intervals.

A communication path connecting the communication device 231 and the LAN 250 is an Internet protocol based on the wireless phone network with an exchange device such as a VoIP (Voice over Internet Protocol) router and a gate way intervening on the way.

The positional information providing server 160 is a server which specifies the position of the IP phone 230 according to the intensity and the direction of the electric waves transmitted from the IP phone 230 upon receipt of them, comprising a communication device 161 capable of the wireless communication and a positional information searching device 162, and the server 160 is connected to the LAN 250 through the communication device 161.

The positional information of the IP phone 230 specified by the positional information providing server 160 may include a combination of the latitude data and the longitude data or a combination of the latitude data, the longitude data, and the altitude data.

Of the data, the latitude data and the longitude data may be read out from a map according to the position of the positional information providing server 160.

The altitude data may be read out from a topographic map by specifying the latitude data and the longitude data.

The positional information providing server 160 may be a server having a GPS. The GPS may be provided with a function for measuring the altitude.

Each program and each data of the server 30, the communication terminal 210, and the communication terminals 220 and 225 are physically stored in the storing medium (not illustrated) of the computers, transferred from the CPUs (not illustrated) of the respective terminals to the memories (not illustrated) depending on the necessity, and carried out.

The function of the invention is characterized in that when a call request is made from the communication terminal 210 of a calling party to the IP phone 230 carried by a called party, the position state detection unit 102 specifies the position of the IP phone 230, the call receiving terminal search unit 103 searches the communication terminals 220 and 225 near the IP phone 230, and that the call receiving terminal control unit 104 informs the communication terminals 220 and 225 of the information for starting the operation of the multimedia communication. It may be realized by installing the circuitry with a program for realizing the above function built-in, in a computer. Alternatively, a program (application) for realizing the characteristic function of the invention may be stored in a storing medium and the program may be executed by a computer, thereby making the computer work as the server 30.

Next, the operation of the communication system according to the example will be described.

At first, the operation for registering various terminal information in the database 107 will be described and then, the calling party's operation of calling the called party will be described.

Hereinafter, the operation for registering the various terminal information in the database 107 will be described.

A business company specified by the organization using the LAN or a system manager specified by the organization registers the identification information of the communication terminals 220 and 225 in the database 107 by using the call management unit 101 before starting the use of the system in the following way.

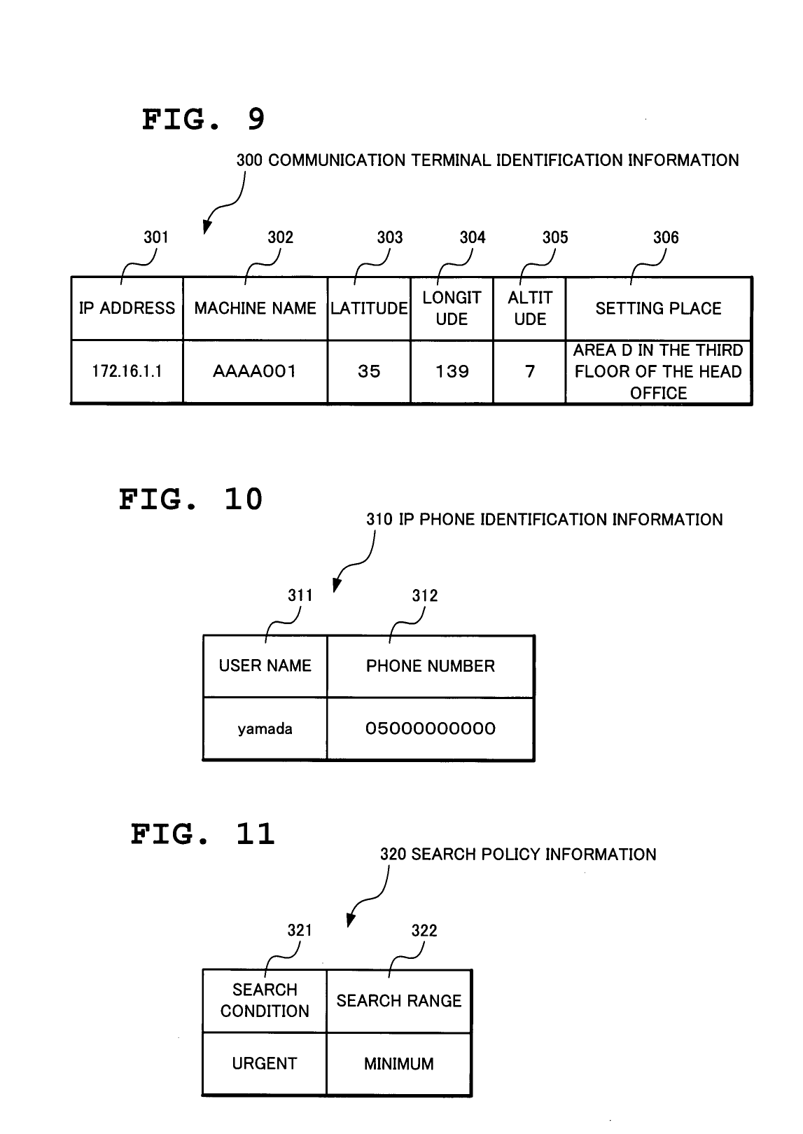

FIG. 9 is a view showing an example of the communication terminal identification information 300 stored in the database 107 according to the example. The communication terminal identification information 300 means the identification information of the communication terminal 220. The identification information (not illustrated) of the communication terminal 225 has the same structure.

Referring to FIG. 9, the system manager registers each data of IP address 301, machine name 302, latitude 303, longitude 304, altitude 305, and setting place 306 as the communication terminal identification information 300 as follows.

The call management unit 101 has a function for displaying each data of the latitude 303, the longitude 304, and the altitude 305 of the setting place of the communication terminal 220 and the setting place 306 when the business company specified by the organization using the LAN or the system manager specified by the organization selects the communication terminal 220 on the indoor map of a building shown on the display (not illustrated) of the server 30. By using the function, the system manager registers the data of the latitude 303, the longitude 304, the altitude 305, and the setting place 306. Further, he or she registers the data of the IP address 301 and the machine name 302 assigned to the communication terminal 220.

The system manager stores the identification information of the IP phone 230 in the database 107 through the call management unit 101. A user carrying the IP phone 230 with him can update the IP phone identification information 310. The IP phone identification information 310 means the identification information of the IP phone 230.

FIG. 10 is a view showing an example of the IP phone identification information 310 stored in the database 107 according to the example.

Referring to FIG. 10, the system manager registers the data of the user name 311 and the telephone number 312 assigned to the IP phone 230. Overlap should be avoided in the user name 311.

The system manager stores the search policy information 320 for setting the search condition at a time of searching the common terminal used by the called party in the database 107 through the call management unit 101.

FIG. 11 is a view showing an example of the search policy information 320 stored in the database 107 according to the example.

Referring to FIG. 11, the system manager registers the data of a search condition 321 and a search area 322 as the search policy information 320. As described in the first example, the search policy means the setting for searching a proper communication terminal according to the situation of the calling party and it is set by the calling party.

Two kinds of data: “urgent” and “ordinal” can be set in the search policy as the urgency level of a call. When the urgency level of the call is “urgent”, the search condition 321 is urgent and the “minimum” showing the shortest distance is registered in the search area 322. When the urgency level of the call is “ordinal”, “ordinal” is registered in the search area 322. When the search area 322 is “ordinal”, the area of 100 meters is set as the search area 322.

The search area 322 is to set the area where the calling party searches the communication terminal used by the called party through the called party terminal searching unit 103, and when the search area 322 is the “minimum”, the communication terminal 220 set at the nearest position from the IP phone 230 carried by the called party is searched. When the search area is “ordinal”, the communication terminal set at a position within 100 meters from the IP phone 230 carried by the called party is searched.

Next, the operation for the calling party calling the called party will be described.

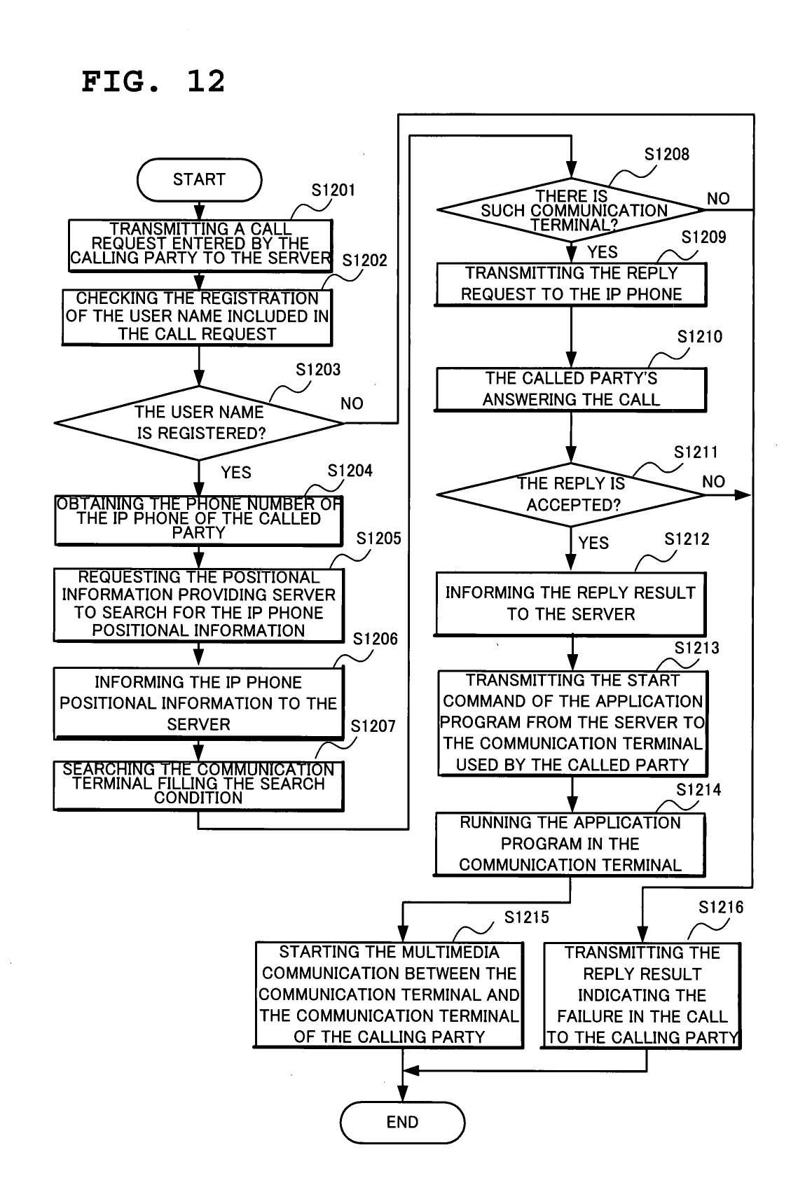

FIG. 12 is a flow chart for describing the operation of the communication system for the calling party calling the called party according to the example. Hereinafter, the relevant portions of the FIG. 8 are referred to depending on the necessity.

The calling party enters his or her own user name to log in the application program 212 installed in the communication terminal 210, and specifies the user name of the called party and the search condition. Here, the user name of the called party and the search condition are the called party information. The called party information means the identification information of the IP phone 230 carried by the called party.

FIG. 13 is a view showing an example of a screen for setting the call condition in the communication terminal 210 according to the example.

The calling party specifies the user name of the called party and the search condition on a call setting screen 400. In the operation example, “yamada” is set as the user name, “urgent” is set as the search condition, and a button indicating “call” is pushed. Thus, a call request is made by the calling party.

The call request includes the calling party information and the called party information. The calling party information includes the user name data of the calling party and the IP address data of the communication terminal 210.

Referring to FIG. 12, the call request entered by the calling party is transmitted to the server 30 through the network card 211 of the communication terminal 210 (Step S1201).

Upon receipt of the call request, the call management unit 101 of the server 30 checks whether the user name data of the called party is registered in the data of the user name 311 of the IP phone identification information 310 stored in the database 107 (Step S1202).

When the user name of the called party included in the received called party information is registered in the database 107 as the identification information 310 of the IP phone (Step S1203), the call management unit 101 obtains the data of the telephone number 312 of the called party (Step S1204).

The case where the call management unit 101 judges that the corresponding user name of the called party is not registered as the search result of the database 107 based on the called party information specified by the calling party, will be described later.

The call management unit 101 provides the obtained telephone number 312, called party information, and calling party information to the position state detection unit 102.

The position state detection unit 102 asks the positional information providing server 160 to search the positional information of the IP phone 230 corresponding to the telephone number (Step S1205).

In an office, the called party always carries the IP phone 230 with him or her and the positional information transmitting device 232 of the IP phone 230 transmits the electric waves to the positional information providing server 160 at regular intervals.

The positional information providing server 160 determines the position of the IP phone based on the intensity (electric field intensity) and the direction of the electric waves received from the IP phone and records the latest positional information of the IP phone in the storing medium (not illustrated) such as a memory. A plurality of the positional information providing servers 160 may be set. In this operation example, the case where the positional information of the IP phone comprises the latitude data, the longitude data, and the altitude data, will be described.

Upon receipt of a search request for the positional information of the IP phone 230 from the position state detection unit 102, the positional information searching device 162 searches the positional information of the IP phone 230 from the information recorded in the positional information providing server 160 and informs it to the position state detection unit 102 of the server 30 (Step S1206).

After receiving the positional information search request of the IP phone 230 from the position state detection unit 102, the positional information providing server 160 obtains the latest positional information of the corresponding IP phone 230 and informs it to the position state detection unit 102.

When obtaining the positional information of the IP phone 230 from the positional information providing server 160, the position state detection unit 102 provides the positional information of the IP phone 230 and the calling party information and the called party information obtained from the call management unit 101, to the called party terminal searching unit 103.

The called party terminal searching unit 103 compares the data of the latitude 303, the longitude 304, and the altitude 305 of the communication terminal registered in the database 107 with the positional information of the IP phone 230 received from the position state detection unit 102 and searches the communication terminal which fills the search condition 321 included in the called party information (Step S1207).

In this operation example, because the search condition 321 is “urgent”, the search policy information with the search condition “urgent” of the search policy information 310 registered in the database 107 is searched out and the search area of the search policy information 320 is obtained.

As shown in FIG. 11, because the search area 322 of the search policy information 320 with the search condition 321 registered “urgent” is the “minimum”, the called party terminal searching unit 103 finds out the communication terminal 220 near to the IP phone 230 (Step S1208).

Although a plurality of the communication terminals 220 and 225 are set, a description will be made assuming that the communication terminal 220 is nearest to the position of the IP phone 230.

The case where the called party terminal searching unit 103 cannot find the communication terminal 220 corresponding to the search condition 321 specified by the calling party (Step S1208) will be described later.

The called party terminal searching unit 103 obtains the data of the IP address 301, the machine name 302, and the setting place 306 of the communication terminal 220 from the database 107 and transmits a reply request including the data of the machine name 302 and the setting place 306 and the calling party information obtained from the position state detection unit 102 to the IP phone 230 (Step S1209).

When the called party receives the reply request from the IP phone 230, a fact of having a call from the calling party and the information of the communication terminal 220 used for answering the call are displayed on the display (not illustrated) of the IP phone 230.

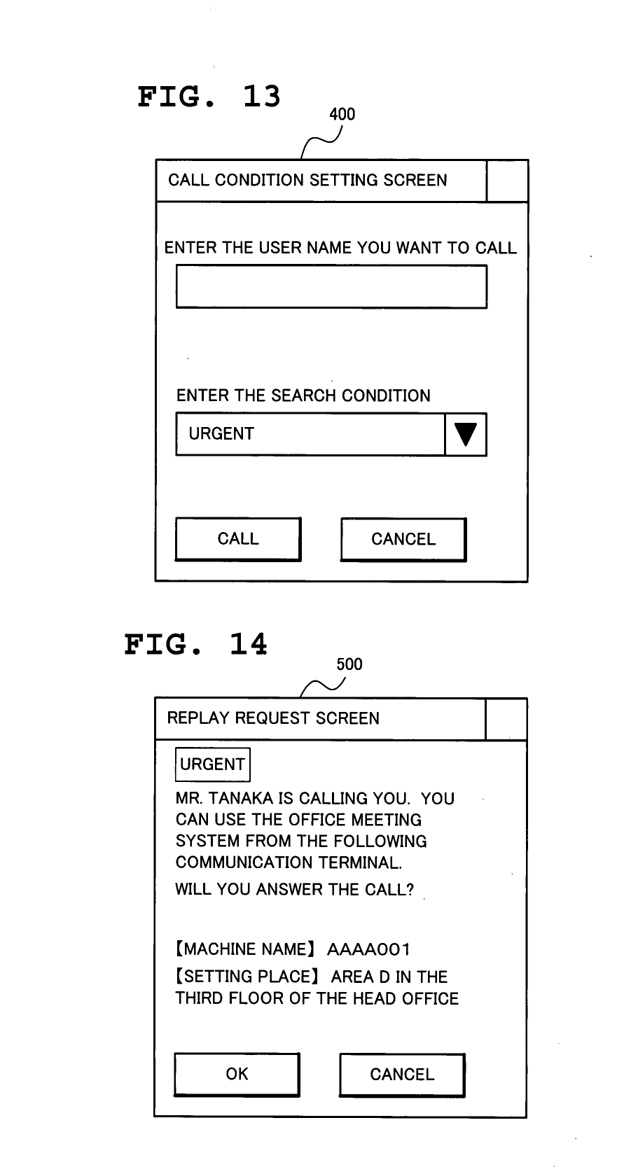

FIG. 14 is an example of the reply request displayed on the screen of the IP phone 230 according to the example. The data of the machine name 302 and the setting place 306 of the communication terminal 220 is displayed in the reply request. When the called party answers the call looking at the reply request screen 500 (Step S1210), he or she pushes the button of “OK” (Step S1211).

When the called party replies to the reply request using the IP phone 230, the reply result is notified to the called party terminal searching unit 103 of the server 30 (Step S1212).

When the called party sees the reply request screen 500 but cannot answer the call (Step S1210), he or she pushes the “cancel” button (Step S1211).

The called party terminal searching unit 103 transmits the received reply result and the data of the IP address 301 of the communication terminal 220 obtained from the database 107 to the call receiving terminal control unit 104.

The call receiving terminal control unit 104 confirms the success in the call from the reply result received from the called party terminal searching unit 103 and based on the data of the IP address 301 of the communication terminal 220 received from the called party terminal searching unit 103, it establishes a connection to the communication terminal 220 through the network card 106. Further, the call receiving terminal control unit 104 of the server 30 transmits a command for remotely starting up an application program 222 installed in the communication terminal 220, to the communication terminal 220 (Step S1213).

The communication terminal 220 receives the starting command of the application program 222 through the network card 221 and carries out the program (Step S1214).

Based on the terminal information displayed on the reply request screen 500, the called party looks for the communication terminal 220 set in an office. Because a tag with the machine name is attached to the communication terminal 220, when a plurality of the terminals are set near the displayed setting place, the called party may look for the terminal according to the tag.

Since the application program 222 has already started up in the communication terminal 220, the called party enters his or her own user name and logs in to the application program 222. A connection between the communication terminal 220 and the communication terminal 210 of the calling party is established, to start the multimedia communication (Step S1215).

When there is no corresponding user name of the called party (Step S1203), in the call management unit 101, as the result of searching the database 107 based on the called party information specified by the calling party, when the called party terminal searching unit 103 cannot find the communication terminal 220 corresponding to the search condition specified by the calling party (Step S1208), or when the reply result of refusing the call is received from the IP phone 230 of the called party (Step S1211), the called party terminal detecting unit 103 of the server 30 transmits the reply result showing the failure in the call to the communication terminal 210 of the calling party (Step S1216) in any case of the above.

The application program 212 receiving the reply result from the server 30 displays the message of the reply result on the display (not illustrated) of the communication terminal 210.

In the example, although the example for establishing the multimedia communication between the calling party and the called party has been described, it is needless to say that the example may be similarly applied to the communication other than the multimedia communication.

According to the example, in the organization such as company, shop, and school, a calling party can call a called party on a move and the called party can establish the multimedia communication with the calling party by using the communication terminal 220.

This is because, by using the IP phone 230 always carried by the called party, the position of the moving called party is determined dynamically and the communication terminals 220 and 225 to be used by the called party are automatically searched.

The server 30 of a semiconductor integrated circuit of the invention can be realized in a way of software by performing a communication control program 35 for carrying out the above mentioned means respectively in the server 30 that is the computer processor. The communication control program 35 is stored in the recording medium such as the magnetic disk, the semiconductor memory, and the like and loaded from the recording medium to the server 30, to control the operation, thereby realizing the respective functions as mentioned above.

### Second Exemplary Example

Hereinafter, the second example of the invention will be described in detail referring to the drawings. This example corresponds to the second exemplary embodiment.

In the example, the communication system in which a sales supporting staff in an office can communicate with a sales staff out of the office will be described.

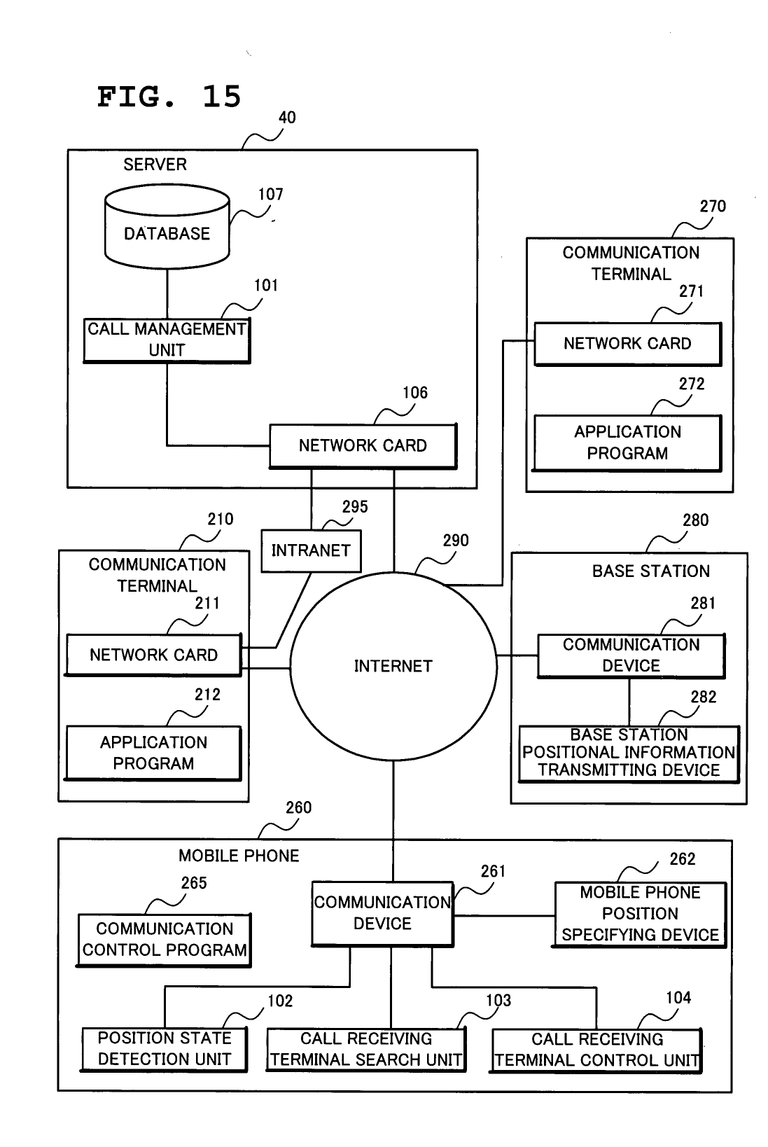

FIG. 15 is a block diagram showing the structure of the communication system according to the example.

The communication system according to the example comprises a server 40, a communication terminal 210, a mobile phone 260, a communication terminal 270, and a base station 280.

The server 40, the mobile phone 260, the communication terminal 270, and the base station 280 are connected to each other through the Internet 290.

The server 40 is connected to the communication terminal 210 through an intranet 295.

The server 40 receives a call request from the communication terminal 210 and it is set within an office. The server 40 comprises a call management unit 101, a database 107, and a network card 106 corresponding to the Ethernet (R). The server 40 is connected to the Internet 290 and the intranet 295 through the network card 106. The server 40 is connected to the Internet 290 through a proxy server (not illustrated).

The communication terminal 210 is a communication terminal used by the sales supporting staff in the office, including a network card 211 corresponding to the Ethernet (R) and an application program 212 for carrying out a sales supporting application. The communication terminal 210 is connected to the intranet 295 within the office through the network card 211. The application program 212 is a Web application.

The mobile phone 260 is a communication terminal which is carried by a sales staff out of the office with a non-contact IC card mounted thereon. The mobile phone 260 comprises a position state detection unit 102, a call receiving terminal search unit 103, a call receiving terminal control unit 104, a communication device 261 capable of infrared communication and wireless communication, and a mobile phone position specifying device 262, and it can be connected to the Internet 290 through the communication device 261. The communication path connecting the communication device 261 and the Internet 290 is a network used by a cell phone company and includes the exchange device such as a router and a gate way on the way.

The mobile phone 260 receives the electric waves including the positional information of the base station 280 from the base station 280 described later and based on the intensity (electric field intensity) and the propagation direction of the electric waves transmitted from the base station 280 and the positional information of the base station 280, the position of the mobile phone 260 can be specified.

The positional information specified by the mobile phone 260 may comprise a combination of the latitude data and the longitude data or a combination of the latitude data, the longitude data, and the altitude data.

Of the data, the latitude data and the longitude data may be read out from a map based on the position of the base station 280.

The altitude data may be read out from a topographic map by specifying the latitude data and the longitude data.

The base station 280 may be provided with a GPS. The GPS may be provided with a function for measuring the altitude.

The communication terminal 270 is a communication terminal used by a sales staff upon receipt of a call through the mobile phone 260, including a network card 271 corresponding to the Ethernet (R) and an application program 272 for carrying the sales supporting application, and it is connected to the Internet 290 through the network card 271. The application program 272 is a Web application. There is a plurality of communication terminals (not illustrated) other than the communication terminal 270.

The communication terminal 270 is a communication terminal of a business company providing a communication service and set in the public place. The communication terminals 270 may be also set in an internet café and a station in addition to the public place. The business company providing the communication service may be a communication carrier or the other business company.

The base station 280 has a function of transmitting the electric waves including its own positional information to the mobile phone 260 at regular intervals, comprising a communication device 281 capable of wireless communication and a base station positional information transmitting device 282 which transmits the own positional information. The base station 280 is connected to the Internet 290 through the communication device 281.

It is assumed that the program, data, and database respectively in the server 40, the communication terminal 210, and the communication terminal 270 are physically stored in the hard disks (not illustrated) of the respective computers and respectively transmitted from the CPUs (not illustrated) of the terminals to the memories (not illustrated) to run. In the case of the mobile phone 260, it is assumed that each program is transmitted to the memory (not illustrated), to run.

The function of the invention is characterized in that when a call request is transmitted from the communication terminal 210 of the calling party to the mobile phone 260 carried by the called party, the position state detection unit 102 specifies the position of the mobile phone 260, the call receiving terminal search unit 103 searches the communication terminal 270 near the mobile phone 260, and that the call receiving terminal control unit 104 informs the communication terminal 270 of the information for starting the operation of the multimedia communication. It can be realized by installing the circuitry with a program for realizing the above function built-in, in a computer. Alternatively, a program (application) for realizing the characteristic function of the invention may be stored in a storing medium and the program may be executed by a computer, thereby making the computer work as the server 40.

Next, the operation of the communication system according to the example will be described. At first, the operation for registering the respective terminal information in the database 107 will be described, and next, the operation of a calling party specifying a called party to call the called party will be described.

Hereinafter, the operation for registering the respective terminal information in the database 107 will be described.

Before the system operation starts, a system manager specified by the business company providing the communication service to operate the server 40 starts up the call management unit 101, refers to the server (not illustrated) collecting the identification information of the communication terminal 270, obtains the identification information of the communication terminal 270 from the server, and stores it in the database 107. In this way, the call management unit 101 has a function for obtaining the latest identification information of the communication terminal 270 from the server collecting the identification information of the communication terminal 270 and storing it in the database 107. In the following description, the function will be referred to as a transcribe function of the call management unit 101.

Next, the identification information of the communication terminal will be described.

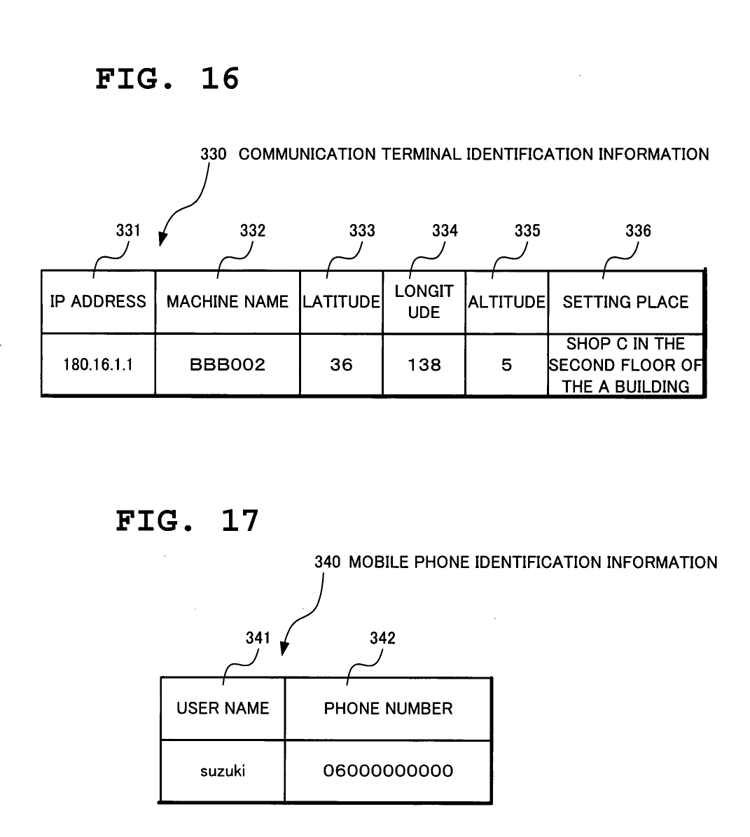

FIG. 16 is a view showing an example of communication terminal identification information 330 stored in the database 107 according to the example. The communication terminal identification information 330 is the identification information of the communication terminal 270.

Referring to FIG. 16, data of IP address 331, machine name 332, latitude 333, longitude 334, altitude 335, and setting place 336, that is the communication terminal identification information 330 of the communication terminal 270, is registered owing to the transcribe function of the call management unit 101. The data of the setting place 336 includes the information such as address, building name, and shop name.

The system manager starts up the call management unit 101 to register the identification information of the mobile phone 260 carried by the sales person in the database 107. A user carrying the non-contact mobile phone 260 can update the identification information of the mobile phone 260.

Next, the identification information of the mobile phone 260 will be described referring to FIG. 17.

FIG. 17 is a view showing an example of mobile phone identification information 340 stored in the database 107 according to the example. The mobile phone identification information 340 is the identification information of the mobile phone 260.

Referring to FIG. 17, the system manager registers each data of user name 341 and telephone number 342 assigned to the mobile phone 260. The data of the user name 341 should be set not to overlap with the other user name.

Such an operation will be described that a sales supporting staff who is a calling party and stays in an office specifies a sales person who is a called party out of the office, searches the communication terminal 270 to be used by the called party, and calls the called party.

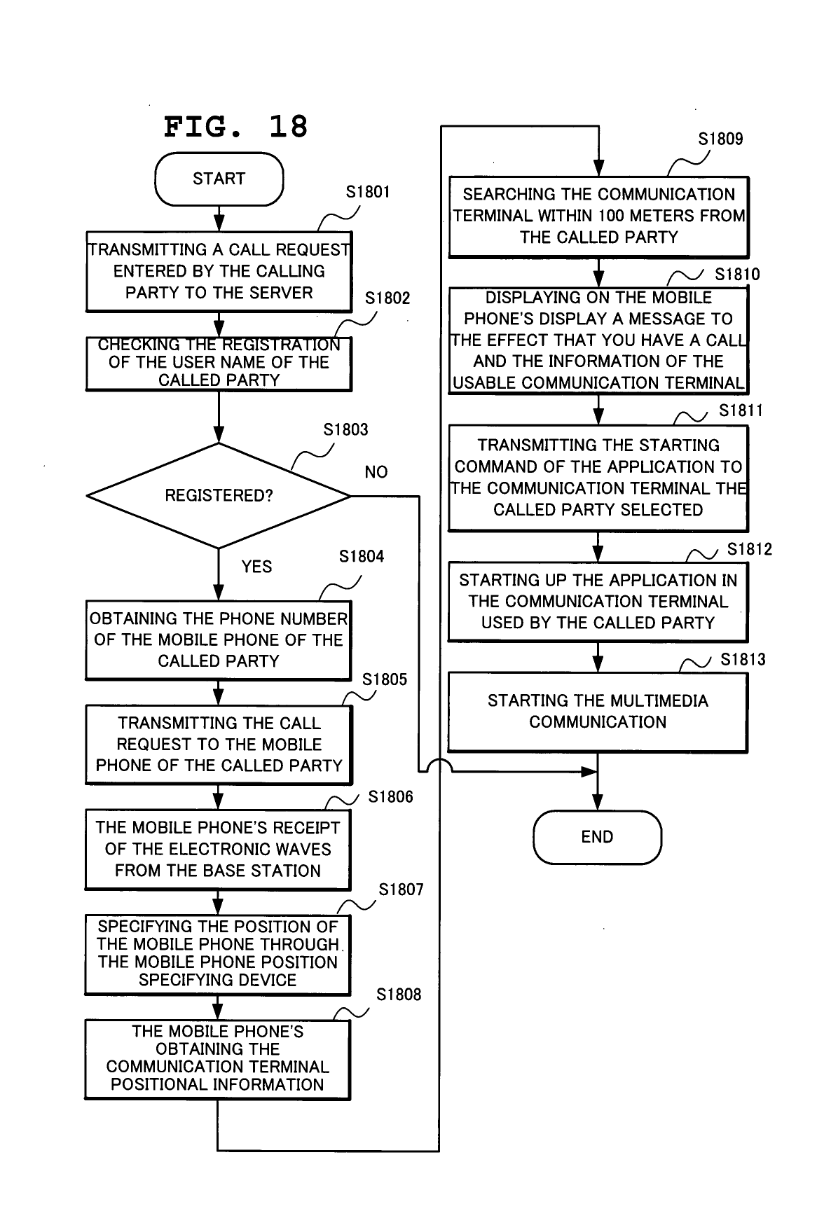

FIG. 18 is a flow chart for describing the operation of the communication system for the calling party calling the called party according to the example. In the following description, the relevant portions of FIG. 15, FIG. 16, and FIG. 17 are referred to depending on the necessity. The case where the positional information of the mobile phone 260 comprises the latitude data, the longitude data, and the altitude data will be described.

The calling party enters the user name of the calling party to log in and specifies the user name of the called party that is the wanted sales person, according to the display of the application program 212 installed in the communication terminal 210.

Here, assume that the user name of the called party is included in the called party information.

Referring to FIG. 18, a call request including the calling party information and the called party information which is entered by the calling party is transmitted to the server 40 through the network card 211 of the communication terminal 210 (Step S1801).

The user name of the calling party and the IP address of the communication terminal 210 are included in the calling party information.

Upon receipt of the call request, the call management unit 101 of the server 40 checks whether the user name of the called party included in the call request is registered in the user name of the mobile phone identification information 340 (Step S1802).

When the user name of the called party included in the received called party information is registered in the database 107 (Step S1803), the call management unit 101 obtains the data of the telephone number 342 registered in the mobile phone identification information 340 (Step S1804).

When the user name of the called party is not registered in the database 107, the processing is finished.

Based on the obtained telephone number 342, the call management unit 101 transmits the call request including the called party information and the calling party information to the corresponding mobile phone 260 (Step S1805).

Each program installed in the mobile phone 260 is in a state of waiting for instruction after startup and always under the condition capable of communicating with the server 40.

The base station positional information transmitting device 282 of the base station 280 transmits the electric waves including its own positional information through the communication device 281 at regular intervals. When the position state detection unit 102 of the mobile phone 260 receives the call request from the server 40, the mobile phone position specifying device 262 receives the electric waves including the positional information of the base station 280 from the base station 280 near the called party (Step S1806).

Based on the intensity (electric field intensity) and the propagation direction of the electric waves transmitted from the base station 280, the mobile phone position specifying device 262 specifies the position of the mobile phone 260 (Step S1807).

The positional information specified by the mobile phone position specifying device 262 comprises the latitude data, the longitude data, and the altitude data.

When getting the positional information of the mobile phone 260 from the mobile phone position specifying device 262, the position state detection unit 102 provides the positional information and the calling party information received from the server 40 to the call receiving terminal search unit 103.

Next, the call receiving terminal search unit 103 obtains each data of the latitude 333, the longitude 334, and the altitude 335 that is the positional information of the communication terminal from the database 107 of the server 40, as for a plurality of the communication terminals (Step S1808).

The call receiving terminal search unit 103 compares the positional information of the mobile phone 260 received from the position state detection unit 102 with the positional information of the communication terminal including the data of the latitude 333, the longitude 334, and the altitude 335 and searches the communication terminal set within hundreds meters from the position of the mobile phone 260 (Step S1809).

Here, assume that two communication terminals are picked up in addition to the communication terminal 270 and that three terminals are usable by the called party.

The call receiving terminal search unit 103 obtains the data of the IP address 331, machine name 332, and setting place 336 for the two communication terminals from the database 107 of the server 40, in addition to the data of the communication terminal 270.

Based on the call request including the data of the machine name 332 and setting place 336 and the calling party information received from the position state detection unit 102, the call receiving terminal search unit 103 displays the information to the effect that there is a call from the calling party and the information for the three terminals including the communication terminal 270 used for answering the call, on the display (not illustrated) of the mobile phone 260 (Step S1810).

The called party selects the one communication terminal 270 looking at the information of the three communication terminals displayed on the mobile phone 260. The called party moves to the place in which the selected communication terminal 270 is set.

The called party holds the mobile phone 260 over the non-contact type card reader of the communication terminal 270. The holding way is the same as in the case where a user makes the card reader read out the non-contact type card information such as a commuter pass. By holding the mobile phone 260 over the reader, the non-contact type card reader provided in the communication terminal 270 can read out the IC card information included in the mobile phone 260.

Owing to this holding operation of the mobile phone 260, the call receiving terminal control unit 104 transmits the calling party information received from the call receiving terminal search unit 103 and the command for remotely starting up the application program 272 installed in the communication terminal 270 to the selected communication terminal 270 (Step S1811).

Communication between the mobile phone 260 and the communication terminal 270 is established by using the feeble electric waves.

The communication terminal 270 receives the starting command of the application program 272 through the network card 271 and runs the program (Step S1812).

When the communication terminal 270 starts up the application program 272, the called party enters his or her user name to log in to the application program 272. When the called party logs in to the application program 272, the communication terminal 270 is connected to the communication terminal 210 of the calling party, hence to start the multimedia communication (Step S1813).

According to the communications system of the example, a calling party can specify the position of a moving called party dynamically by using the mobile phone 260 carried by the called party when he or she goes out and search the communication terminal 270 which may be used by the called party, thereby saving the labor of the called party for searching his or her usable terminal and starting the communication with the calling party smoothly.

Since the mobile phone 260 is provided with the program for searching and controlling the call terminal, the search result can be updated at any time even when the called party is moving.

Since the application program 272 of the communication terminal 270 is started up by the operation of the called party, it is possible to start up the application program 272 according to the called party's convenience.

In the above mentioned example, although the case where the called party carries the mobile phone 260 with him or her has been described, the mobile phone 260 does not have to be a mobile phone with the IC card mounted there but it may be the normal mobile phone without the IC card.

In this case, the communication terminal 270 may be provided with a contact type card reader instead of the non-contact type card reader described in the above example.

Although the above mentioned example takes an example in the case where a calling party in an office calls a called party moving out of the office by using the terminal within the office, a calling party out of the office can call a called party moving in the office, using the terminal set outside the office through the public network. In this case, the server is set outside of the office in addition to the structure of FIG. 15 and the communication terminal is set in the office instead of the communication terminal 270.

Although the example of performing the multimedia communication between the calling party and called party has been described in the above mentioned example, it is needless to say that the example can be similarly applied to the communication other than the multimedia communication.

According to the example, a calling party in the organization such as company, shop, and school can call a called party on a move and the called party can establish the multimedia communication with the calling party, using the communication terminal 270.

This is because the called party specifies his or her position on a move, using his or her always carrying mobile phone 260 and searches his or her usable communication terminal 270.

It is needless to say that the mobile phone 260 of the invention can realize its operation in a way of hardware, or it can realize the above operation in a way of software by running the communication control program (application) 265 for carrying out the above units, in the mobile terminal 260 that is a computer processor. The communication control program 265 is stored in a recording medium such as a magnetic disk, a semiconductor memory, and the like and loaded from the recording medium into the mobile phone 260, to control the operation, thereby realizing the above-mentioned functions.

According to the invention, it is possible to perform a data communication between a specified user having a mobile terminal and the communication terminal without being restricted to the performance of the mobile terminal. Namely, it is possible that a calling party calls a called party on a move and the called party performs the multimedia communication with the calling party, using the communication terminal.

The invention relates to a communication system, and more particularly, it is to realize the communication system in which a calling party can call a called party on a move and the called party can perform the multimedia communication with the calling party, using the communication terminal of a business company providing a communication service.

According to the invention, when a calling party makes a call request for a called party on a move, the information of the communication terminal used by the called party is transmitted to the called party and the called party can perform the multimedia communication with the calling party by using the above communication terminal. The outline will be described as follows.

At first, the calling party transmits the call request from the communication terminal to a server for controlling the communication about the call request for the called party. The server searches the positional information of the mobile terminal carried by the called party after confirming that the called party has been registered. The positional information of the mobile terminal is transmitted from the positional information providing server to the server. Since the called party always carries the mobile terminal with him or her, the position of the mobile terminal agrees with the position of the called party.

The mobile terminal is provided with a communication function and a mail function so that the called party may receive notification, but not provided with a function of multimedia communication including video, image, or sound of large capacity. Further, it is provided with a vibration function or sound function to notify the incoming call, other than the mail function.

Upon receipt of the positional information of the terminal, the server checks a communication terminal of a business company located near the terminal, and when there is the communication terminal of the business company near the called party, it transmits a reply request to the terminal of the called party. The called party transmits the reply result corresponding to the reply request to the server.

When confirming that the called party accepts the reply request, the server transmits such a message as starting the multimedia communication to the communication terminal used by the called party.

On the other hand, the server transmits the reply result indicating success in calling the called party to the communication terminal of the calling party who is waiting for the result.

As mentioned above, it is possible to perform a communication by multimedia including the video, image, and sound of large capacity, between the communication terminal of the calling party and the communication terminal used by the called party.

According to the invention, it is possible to perform a data communication with a specified user carrying a mobile terminal without being restricted to the performance of the mobile terminal.

This is because the specified communication terminal requesting a communication with the specified user carrying the mobile terminal informs the positional information for specifying the position of the communication terminal usable by the specified user, of a plurality of the communication terminals, to the mobile terminal of the specified user.

While the invention has been particularly shown and described with reference to embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from Japanese patent application No. 2005-049787, filed on Feb. 24, 2005, the disclosure of which is incorporated herein in its entirety by reference.

1-51. (canceled)

52. A communication system of performing a data communication between a plurality of communication terminals connected through a network, comprising:
a storing unit which previously stores the positional information for specifying the position of said communication terminal, wherein
a specified communication terminal requesting a communication with a specified user having a mobile terminal
searches the positional information of said communication terminal usable by said specified user from said positional information of said storing unit, based on the positional information of said mobile terminal obtained from a positional information providing server which provides the positional information indicating the current position of the mobile terminal, or the positional information of said mobile terminal transmitted from said mobile terminal having a position detecting function of detecting the own positional information, wherein
said specified communication terminal
informs the mobile terminal of said specified user of positional information for specifying position of said communication terminal usable by said specified user of said plurality of communication terminals.

53. The communication system according to claim 52, comprising:
a server having a storing unit which previously stores the positional information for specifying the position of said communication terminal, wherein
the mobile terminal of said specified user searches the positional information of said communication terminal usable by the specified user from said positional information obtained from said server, based on own positional information.

54. The communication system according to claim 53, comprising
a positional information providing unit which provides the positional information indicating the current position of the mobile terminal of said specified user, wherein
said server searches the positional information of said communication terminal usable by the specified user from said positional information of said storing unit, based on the positional information of said mobile terminal obtained from said positional information providing unit.

55. The communication system according to claim 53, wherein
the mobile terminal of said specified user comprises a position detecting function of detecting the own positional information, and
said server searches the positional information of said communication terminal usable by the specified user from said positional information of said storing unit, based on the positional information of said mobile terminal transmitted from said mobile terminal.

56. The communication system according to claim 52, wherein
the mobile terminal of said specified user comprises a position detecting function of detecting the own positional information and a storing unit which previously stores the positional information for specifying the positions of said communication terminals, and
searches the positional information of said communication terminal usable by the user from said positional information of said storing unit, based on the own positional information.

57. The communication system according to claim 52, wherein
the positional information of said communication terminal within a predetermined range from the mobile terminal of said specified user is searched as said communication terminal usable by said specified user.

58. The communication system according to claim 57, wherein
the positional information of said communication terminal nearest to the mobile terminal of said specified user is searched as said communication terminal usable by said specified user.

59. The communication system according to claim 52, comprising:
a destination-positional information obtaining unit which obtains the positional information indicating the position of a destination of the mobile terminal of said specified user, wherein
the positional information of said communication terminal located at said destination of the mobile terminal of said specified user is searched as said communication terminal usable by said specified user, based on said destination position obtained by said destination-positional information obtaining unit.

60. The communication system according to claim 59, wherein
said specified communication terminal comprises a destination-positional information obtaining unit which obtains the positional information indicating the position of a destination of the mobile terminal of said specified user, and
searches the positional information of said communication terminal located at the destination of the mobile terminal of said specified user as said communication terminal usable by said specified user, based on the position of said destination obtained by said destination-positional information obtaining unit.

61. The communication system according to claim 52, wherein
the positional information of said communication terminal which said specified user is authorized to use is searched as said communication terminal usable by said specified user.

62. The communication system according to claim 61, wherein
said specified communication terminal has authorization obtaining information for obtaining said use authorization.

63. The communication system according to claim 61, comprising:
an urgent level obtaining unit which obtains an urgent level of requiring a communication with the specified user carrying the mobile terminal, wherein
said specified user searches the positional information of said communication terminal located at a position depending on the urgent level from the mobile terminal of said specified user as said communication terminal usable by said specified user.

64. The communication system according to claim 52, comprising:
an informing unit which informs the communication terminal usable by said specified user of information for starting a communication operation between the communication terminals.

65. A server for use in a communication system of performing a data communication between a plurality of communication terminals connected through a network, comprising:
a storing unit which previously stores the positional information for specifying the position of said communication terminal, wherein
said server
searches the positional information of said communication terminal usable by said specified user from said positional information stored in said storing unit, based on the positional information of said mobile terminal detected through a positional information detecting function of detecting the positional information indicating the current position of the mobile terminal of said specified user, or the positional information for specifying the position of said mobile terminal obtained through said network, and
upon request of a communication with a specified user having a mobile terminal, informs the mobile terminal of said specified user of the positional information for specifying position of said communication terminal usable by said specified user of said plurality of communication terminals.

66. The server according to claim 65, wherein
the positional information of said communication terminal within a predetermined range from the mobile terminal of said specified user is searched as said communication terminal usable by said specified user, based on the positional information for specifying the position of said communication terminal and the positional information of said mobile terminal.

67. The server according to claim 66, wherein
the positional information of said communication terminal nearest to the mobile terminal of said specified user is searched as said communication terminal usable by said specified user.

68. The server according to claim 65, comprising
a destination-positional information obtaining function of obtaining the positional information indicating the position of a destination of the mobile terminal of said specified user, wherein
the positional information of said communication terminal located at a predetermined position from the destination of the mobile terminal of said specified user is searched as said communication terminal usable by said specified user, based on said destination position obtained according to said destination-positional information obtaining function.

69. The server according to claim 65, wherein
the positional information of said communication terminal which said specified user is authorized to use is searched as said communication terminal usable by said specified user.

70. The server according to claim 69, wherein
based on authorization obtaining information for obtaining said use authorization belonging to said specified communication terminal, which is obtained through said network, the positional information of said communication terminal which said specified user is authorized to use is searched as said communication terminal usable by said specified user.

71. The server according to claim 65, comprising
an urgent level obtaining function of obtaining an urgent level of requiring a communication with the specified user carrying the mobile terminal, wherein
the positional information of said communication terminal located at a position depending on the urgent level from the mobile terminal of said specified user is searched as said communication terminal usable by said specified user.

72. The server according to claim 65, wherein
the positional information of said communication terminal located at a position depending on the urgent level from the mobile terminal of the specified user is searched as said communication terminal usable by said specified user, based on the urgent level of requiring the communication with said specified user carrying said mobile terminal obtained through said network.

73. The server according to claim 65, comprising
an informing function of informing said communication terminal usable by said specified user of information for starting a communication operation between the communication terminals.

74. A mobile terminal carried by a specified user receiving a communication request from a specified one, of a plurality of communication terminals, for performing a data communication, connected through a network, comprising:
a storing unit which previously stores the positional information for specifying the position of said communication terminal, wherein
searches the positional information of said communication terminal usable by said specified user from said positional information stored in said storing unit, based on the own positional information obtained through said network, or the own positional information detected by a position detecting function of detecting the own positional information, and
obtains the positional information for specifying the position of said communication terminal usable by said specified user, of the plurality of said communication terminals.

75. The mobile terminal according to claim 74, which
searches the positional information of said communication terminal usable by said specified user from said positional information for specifying the position of said communication terminal obtained through said network, based on the own positional information.

76. The mobile terminal according to claim 74, comprising:
a position detecting function of detecting the own positional information and a storing function of previously storing the positional information for specifying the position of said communication terminal, which
searches the positional information of said communication terminal usable by the specified user from said positional information obtained through said storing function, based on the own positional information.

77. The mobile terminal according to claim 74, which
searches the positional information of said communication terminal located within a predetermined range from this mobile terminal as said communication terminal usable by said specified user.

78. The mobile terminal according to claim 77, which
searches the positional information of said communication terminal nearest to this mobile terminal as said communication terminal usable by said specified user.

79. The mobile terminal according to claim 74, comprising
a destination-positional information obtaining function of obtaining the positional information indicating the position of the own destination, which
searches the positional information of said communication terminal located at said own destination as said communication terminal usable by said specified user, based on said destination position obtained through said destination-positional information obtaining function.

80. The mobile terminal according to claim 79, which
searches the positional information of said communication terminal located at said destination position of the mobile terminal of said specified user as said communication terminal usable by said specified user, based on the received positional information of said destination.

81. The mobile terminal according to claim 74, which
searches the positional information of said communication terminal which said specified user is authorized to use, as said communication terminal usable by said specified user.

82. The mobile terminal according to claim 74, wherein
said specified communication terminal has authorization obtaining information for obtaining said use authorization of said communication terminal.

83. The mobile terminal according to claim 74, which
receives an urgent level of requiring a communication with said specified user carrying the mobile terminal, and
searches the positional information of said communication terminal located at a position depending on said urgent level from the mobile terminal of said specified user as said communication terminal usable by said specified user.

84. The mobile terminal according to claim 74, which
informs the positional information of said communication terminal notified or searched to said specified user.

85. The mobile terminal according to claim 74, which
informs said received urgent level to said specified user.

86. The mobile terminal according to claim 74, which
stores a program enabling said specified data communication.

87. A communication control program, which is executed on a computer processor, for use in a communication system of performing a data communication between a plurality of communication terminals connected through a network, which program makes said computer processor execute
a storing function of previously storing positional information for specifying the position of said communication terminal,
a positional information obtaining function of obtaining the positional information indicating the current position of a mobile terminal carried by a specified user which said specified communication terminal requests a communication with,
a searching function of searching the positional information of said communication terminal within a predetermined range from the mobile terminal of said specified user as said communication terminal usable by said specified user from said positional information stored by said storing function, based on the positional information of said mobile terminal obtained by said positional information detecting function, or the positional information of said mobile terminal transmitted from said mobile terminal having a position detecting function of detecting the own positional information, and
an informing function of informing said positional information stored for specifying the position of said communication terminal usable by said specified user, of said communication terminals, to the mobile terminal of said specified user who obtains said positional information through said positional information obtaining function.

88. The communication control program according to claim 87, which
makes said computer processor execute
a function of searching the positional information of said communication terminal located within a predetermined range from the mobile terminal of said specified user, as said communication terminal usable by said specified user.

89. The communication control program according to claim 87, which makes said computer processor execute
a function of searching the positional information of said communication terminal located nearest to the mobile terminal of said specified user, as said communication terminal usable by said specified user.

90. The communication control program according to claim 87, which makes said computer processor execute
a destination-positional information obtaining function of obtaining the positional information indicating the position of a destination of the mobile terminal of said specified user, and
a function of searching the positional information of said communication terminal located at said destination of the mobile terminal of said specified user as said communication terminal usable by said specified user, based on said destination position obtained through said destination-positional information obtaining function.

91. The communication control program according to claim 87, which makes said computer processor execute
a function of searching the positional information of said communication terminal which said specified user is authorized to use, as said communication terminal usable by said specified user.

92. The communication control program according to claim 87, which makes said computer processor execute
an urgent level obtaining function of obtaining an urgent level of requesting a communication with said specified user carrying the mobile terminal, and
a function of searching the positional information of said communication terminal located at a position depending on said urgent level from the mobile terminal of said specified user, as said communication terminal usable by said specified user.

93. The communication control program according to claim 87, which makes said computer processor execute
a function of informing information for starting a communication operation between the communication terminals to said communication terminal usable by said specified user.
